(19) United States
(12) Patent Application Publication
(10) Pub. No.: US 2026/0353284 A1
(43) Pub. Date: Nov. 5, 2026

(54) SYSTEMS AND METHODS FOR SELECTIVE PAGING FOR WAKE-UP SIGNALS

(71) Applicant: InterDigital Patent Holdings, Inc., Wilmington, DE (US)

(72) Inventors: Nazli Khan Beigi, Longueuil (CA); Young Woo Kwak, Woodbury, NY (US); Moon IL Lee, Melville, NY (US); Paul Marinier, Brossard (CA); Tao Deng, New York, NY (US); Prasanna Herath, Laval (CA); Virgile Garcia, Antibes (FR)

(73) Assignee: InterDigital Patent Holdings, Inc., Wilmington, DE (US)

(21) Appl. No.: 19/199,224

(22) Filed: May 5, 2025

(51) Int. Cl. H04W 52/02

(52) U.S. Cl. CPC H04W 52/0229

(57) ABSTRACT

Methods, apparatuses, and systems are disclosed. In one example, a method performed by a WTRU may comprise receiving configuration information indicating resources associated with WUS monitoring for at least one subgroup of a plurality of subgroups; and monitoring for a WUS polling message in one or more polling occasions associated with a subgroup that is associated with the WTRU. If the WTRU receives the WUS polling message and the WUS polling message indicates that the subgroup associated with the WTRU is active, WTRU may (i) send a response indicating that the WTRU is monitoring for a WUS associated with the subgroup; and/or (ii) monitor for the WUS associated with the subgroup. Otherwise, the WTRU may (i) send a message to request activation of the subgroup that is associated with the WTRU; (ii) monitor a for a WUS associated with a common subgroup; or (iii) deactivate the WUS monitoring.

### BACKGROUND

In existing systems, a wireless transmit/receive unit (WTRU) may use discontinuous reception (DRX) in an RRC_IDLE state and/or an RRC_INACTIVE state in order to reduce power consumption. The WTRU may monitor one paging occasion (PO) per DRX cycle. A PO may comprise a set of physical downlink control channel (PDCCH) monitoring occasions and may comprise multiple time slots (e.g., subframes and/or orthogonal frequency division multiplexing (OFDM) symbols) where paging downlink control information (DCI) may be sent.

### SUMMARY

Methods and apparatuses for operation by a wireless transmit/receive unit (WTRU) are provided.

In an example, a method performed by a WTRU may comprise receiving configuration information, wherein the configuration information indicates resources associated with wake-up signal (WUS) monitoring for at least one subgroup of a plurality of subgroups; monitoring for a WUS polling message in one or more polling occasions associated with a subgroup that is associated with the WTRU; if the WTRU receives the WUS polling message and the WUS polling message indicates the subgroup associated with the WTRU is active: (i) sending a response indicating that the WTRU is monitoring for a WUS associated with the subgroup; and/or (ii) monitoring for a WUS associated with the subgroup; and, if the WTRU does not receive the WUS polling message or if the WTRU receives the WUS polling message and the WUS polling message indicates the subgroup associated with the WTRU is not active: (i) sending a message to request an activation of the subgroup that is associated with the WTRU; (ii) monitoring for a WUS associated with a common subgroup; and/or (iii) deactivating the WUS monitoring.

The common subgroup may be associated with each subgroup of the plurality of subgroups.

The plurality of subgroups may comprise one or more activated subgroups and one or more deactivated subgroups; the common subgroup may be associated with the one or more deactivated subgroups; The one or more deactivated subgroups comprise the subgroup that is associated with the WTRU; and the method may comprise, if the WTRU does not receive the WUS polling message or if the WTRU receives the WUS polling message and the WUS polling message indicates the subgroup associated with the WTRU is not active: monitoring for the WUS associated with the common subgroup based on the association of the common subgroup with the one or more deactivated subgroups.

The method may further comprise, if the WTRU receives the WUS associated with the common subgroup and the WUS message indicates the subgroup associated with the WTRU is not active: waking up a main radio (MR); and monitoring, via the MR, for one or more signals associated with paging.

The method may further comprise, if the WTRU receives the one or more signals associated with paging: sending a response to the one or more signals associated with paging.

The method may further comprise, if the WTRU does not receive the WUS polling message or if the WTRU receives the WUS polling message and the WUS polling message indicates the subgroup associated with the WTRU is not active: determining whether to deactivate the WUS monitoring based on whether a condition is satisfied, wherein the condition may be based on a measured quality parameter.

The condition may indicate a threshold value for the measured quality parameter.

The method may further comprise, if the WTRU does not receive the WUS polling message or if the WTRU receives the WUS polling message and the WUS polling message indicates the subgroup associated with the WTRU is not active: comparing the measured quality parameter to the threshold value; and determining whether to deactivate the WUS monitoring based on the comparison of the measured quality parameter to the threshold value.

Each subgroup of the plurality of subgroups may be respectively associated with one or more beams, zones, or services.

The method may further comprise determining that the WTRU is associated with the subgroup of the plurality of subgroups based on one or more of (i) a synchronization signal block (SSB) measurement, (ii) beam measurements, (iii) a location of the WTRU, or (iv) a service supported by the WTRU.

The method may further comprise determining the subgroup is associated with the WTRU based on an identifier (ID) associated with the WTRU.

The subgroup may comprise a WUS polling subgroup. The WUS polling message may indicate that a wake-up subgroup associated with the WTRU is active for the WUS polling subgroup.

The WUS polling message may indicate that the subgroup associated with the WTRU is active via at least one of a bitmap indication, a codepoint indication, and/or a sequence indication.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 shows a diagram of a procedure for selective paging for WUS based on subgroups.

FIG. 3 illustrates an example flow diagram of an example process (e.g., method) for selective paging for wake-up signals that a WTRU may perform in accordance with some examples found in the present disclosure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

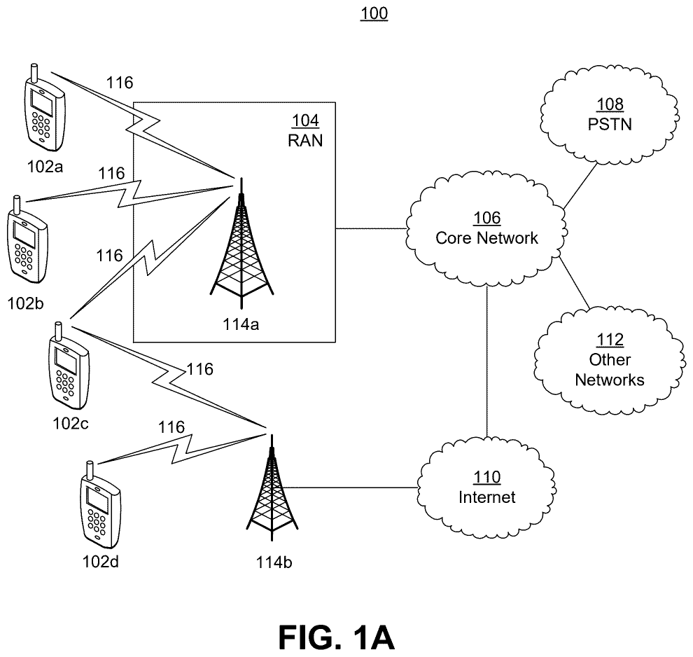

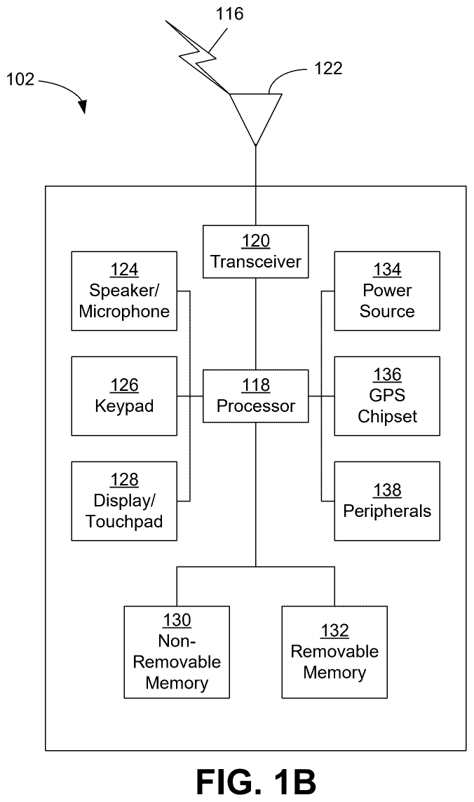

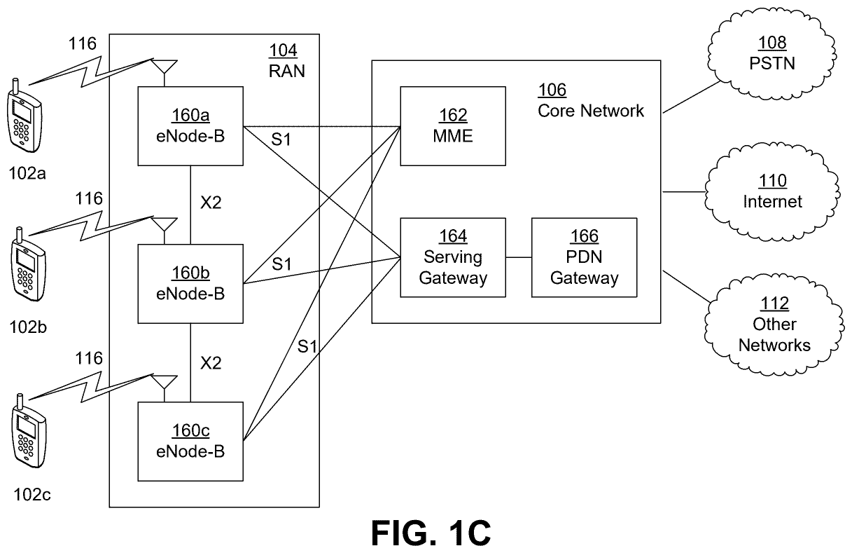

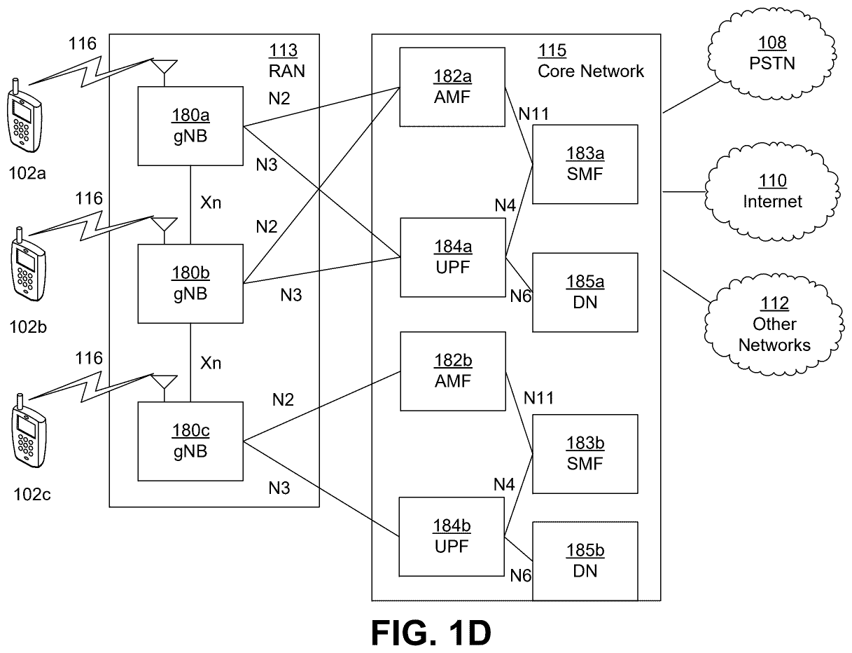

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a diagram illustrating an example communications system 100 in which one or more disclosed embodiments may be implemented. The communications system 100 may be a multiple access system that provides content, such as voice, data, video, messaging, broadcast, etc. to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102 c, 102 d may implement a radio technology such as IEEE 802.11 to establish a wireless local area network (WLAN). In an embodiment, the base station 114b and the WTRUs 102 c, 102 d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received (e.g., as indicated by timing information) from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remain idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of Non-Access Stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems and methods disclosed herein involve a WTRU that may receive configuration information regarding wake-up signal (WUS) polling occasions, during which the WTRU may receive codepoints associated with configured subgroups. If the WTRU receives a first indication of a subgroup that is associated with the WTRU, the WTRU may send a second indication in a configured response time. The WTRU may receive a confirmation of whether the subgroup that is associated with the WTRU is activated or not. Based on the confirmation, the WTRU may determine a mode of operation.

Examples disclosed herein describe various approaches for subgroup polling and/or selective WUS transmission, sending a response to the first indication in WUS polling, use of the second Indication in WUS Polling, and modes of operation

Wake-Up Signal (WUS) monitoring may have the potential to reduce power consumption of WTRUs and/or other small battery-powered devices. This reduction of power consumption may be achieved by using a separate ultra-low power-consumption receiver that may monitor wake-up signals (WUSs) and trigger and/or wake-up a receiver dedicated for data and/or control signal transmission and/or reception.

A WTRU may use discontinuous reception (DRX) in an RRC_IDLE state and/or an RRC_INACTIVE state in order to reduce power consumption. The WTRU may monitor one paging occasion (PO) per DRX cycle. A PO may comprise a set of physical downlink control channel (PDCCH) monitoring occasions and may comprise multiple time slots (e.g., subframes and/or orthogonal frequency division multiplexing (OFDM) symbols) where paging downlink control information (DCI) may be sent.

In multi-beam operations, the WTRU assumes that the same paging message and the same Short Message are repeated in each transmitted beam. As a result, the selection of beam(s) for reception of the paging message and/or Short Message may vary according to WTRU implementation. The paging message may be the same for both radio access network (RAN)-initiated paging and core network (CN)-initiated paging.

The WTRU may use paging early indication (PEI) in RRC_IDLE state and/or RRC_INACTIVE state in order to reduce power consumption. If a PEI configuration is provided in system information, a WTRU in RRC_IDLE state and/or RRC_INACTIVE state that supports PEI (except for WTRUs expecting a multicast session activation notification) may monitor PEI using PEI parameters in system information.

In multi-beam operations, the WTRU assumes that the same PEI is repeated in each transmitted beams. As a result, the selection of the beam(s) for the reception of the PEI may vary according to WTRU implementation.

If a WTRU detects a PEI and the PEI indicates that a subgroup to which the WTRU belongs (e.g., a subgroup that comprises the WTRU) is to monitor the subgroup's associated PO, the WTRU may monitor the associated PO. If the WTRU does not detect a PEI on the associated PO or the PEI does not indicate that the subgroup to which the WTRU belongs is to monitor the associated PO, the WTRU does not have to monitor the associated PO.

If PEI and subgrouping are configured, WTRUs monitoring a same PO may be divided into one or more subgroups. With subgrouping, a WTRU may monitor the associated PO if the value of a corresponding bit for a subgroup to which the WTRU belongs is “1” (e.g., as opposed to “0”) in the PEI corresponding the associated PO.

WUS systems may leverage beam-based frameworks for enhanced capacity, latency, coverage, etc., wherein WUS code points and/or sequences may be transmitted based on different beam directions and/or spatial relations. In systems based on WUS, a WTRU may be configured with monitoring occasions (MOs) to monitor and/or detect potential WUSs. In multi-beam WUS operation, a WTRU may be configured with WUS transmission occasions (WO). Within each WO, one or more WUS MOs may be configured to include one or more configured beams (e.g., all configured beams). At a time, one of multiple candidate codepoint values may be transmitted in a WUS MO. Each candidate codepoint value (e.g., of the multiple candidate codepoint values) may be associated with one or multiple subgroups (SG). Each WUS MO may be associated with one or more beam resources.

In the wake-up signaling procedures, there is the potential for repetition of the same WUS signaling to be performed over multiple (e.g., all) beams and/or areas (e.g., due to WUS escalation). Such repetition may result in a waste of power at a base station (e.g., a gNB). WUS escalation may happen when a network (NW) sends a WUS for a WTRU, but does not receive any responses from the WTRU within configured time-windows. In this scenario, the NW may repeatedly send the WUS in multiple (e.g., all) other beams, cells, zones, etc. Given the possibility that there may be no WTRUs monitoring a specific subgroup in a particular area, zone, and/or beam direction, the repetition of WUS signaling may increase the NW power consumption unnecessarily. Also, due to such WUS escalation, even WTRUs that the network does not intend to page may wake up although these WTRUs might be far away from the WTRUs that the NW intends to page. Unnecessary waking up and associated transition energy from a sleep state to an active state may affect power saving at the WTRUs (e.g., the WTRUs the NW does not intend to page), especially for WTRUs that are configured to enter an ultra-deep sleep state (e.g., in RRC-IDLE state and/or RRC-INACTIVE state).

Thus, the problem of how to avoid unnecessary repetition of WUS signaling in a WUS escalation scenario arises.

As noted above, WUS escalation results in waste of both NW energy and WTRU power. Thus, it would be advantageous to avoid unnecessary repetition of WUS in an escalated scenario.

A WTRU may receive configurations (e.g., configuration information) that indicate WUS polling occasions (POs), during which the WTRU may receive codepoints associated with configured subgroups. The WTRU may send an indication in a configured response time, if the WTRU receives a subgroup (e.g., an indication of a subgroup) that is associated with the WTRU. The WTRU may receive confirmation on whether its subgroup (e.g., a subgroup that comprises the WTRU) is activated or not. Based on such a confirmation, the WTRU may determine a mode of operation (e.g., for the WTRU).

This approach may achieve energy savings for the NW by reducing the number of WUSs as well as WUS overhead for deactivated subgroups. This approach also benefits WTRUs that are in power saving mode, since the WTRUs will not have to wake up unnecessarily due to repeated or frequently escalated WUS transmission for other WTRUs and/or subgroups.

A WTRU may be configured with (or have) an identifier (ID) (e.g., a WTRU ID or a received ID).

The WTRU may determine a wake-up subgroup based on the ID (e.g., the WTRU's wake-up subgroup, which may be a subgroup that comprises the WTRU).

The WTRU may receive configuration information for WUS polling (e.g., vi system information (SI) or radio resource control (RRC)). The configuration information may indicate respective polling resources to monitor for each polling subgroup of a plurality of polling subgroups. Each polling subgroup may be, for example, associated with a set of one or more beams, zones, and/or services.

The WTRU may determine a polling subgroup from the plurality of polling subgroups and may monitor for a WUS polling signal and/or message in one or more polling occasions associated with the determined polling subgroup. As described in the examples below, the WTRU may determine the WUS polling subgroup based on one or more different factors.

In an example, the WTRU may determine the WUS polling subgroup based on measurement(s) such as beam measurements and/or synchronization signal block (SSB) measurement(s).

In an example, the WTRU may determine the WUS polling subgroup based on a beam or a plurality of beams the WTRU uses or will use to monitor for a WUS or for one or more paging-related signals.

In an example, the WTRU may determine the WUS polling subgroup based on the WTRU's location.

In an example, the WTRU may determine the WUS polling subgroup based on the services the WTRU is supporting.

If the WTRU receives a WUS polling message and/or signal and the message and/or signal indicates the WTRU's wake-up subgroup is active for the determined polling subgroup, the WTRU may perform one or more actions (e.g., as described in the examples below).

In an example, if the WTRU receives a WUS polling message that indicates the WTRU's wake-up subgroup is active for the determined polling subgroup, the WTRU may send a response (e.g., signal or message) indicating that the WTRU is monitoring the WUS for the determined polling subgroup and WTRU's wake-up subgroup (e.g., to indicate to the base station to keep the WTRU's wake-up subgroup active).

In an example, if the WTRU receives a WUS polling message that indicates the WTRU's wake-up subgroup is active for the determined polling subgroup, the WTRU may monitor for a WUS associated with the determined polling subgroup. If the WUS associated with the determined polling subgroup is received and indicates the WTRU's wake-up subgroup, the WTRU may wake up (e.g., wake up the main radio (MR) of the WTRU) and may monitor for one or more signals associated with paging. If the WTRU receives a page (e.g., a signal associated with paging), the WTRU may send a response to the page.

If the WTRU receives a WUS polling message and/or signal and the message and/or signal does not indicate the WTRU's wake-up subgroup is active for the determined polling subgroup (or if the WTRU does not receive the polling message and/or signal for the determined polling subgroup), the WTRU may perform one or more actions (e.g., as described in the examples below).

In an example, if the WTRU receives a WUS polling message and/or signal and the message and/or signal does not indicate the WTRU's wake-up subgroup is active for the determined polling subgroup, the WTRU may send a signal and/or message to request activation of the determined polling subgroup and/or to request activation of the WTRU's subgroup for the determined polling subgroup.

In an example, if the WTRU receives a WUS polling message and/or signal and the message and/or signal does not indicate the WTRU's wake-up subgroup is active for the determined polling subgroup, the WTRU may monitor for a WUS associated with the determined polling subgroup. If the WUS associated with the determined polling subgroup is received and indicates a configured wake-up subgroup associated with (e.g., common for) deactivated WTRU wake-up subgroups, the WTRU may wake up (e.g., wake up the MR) and monitor for one or more signals associated with paging. If the WTRU receives a page (e.g., a signal associated with paging), the WTRU may send a response to the page.

Examples provided herein describe approaches for wake-up signaling (WUS). The same examples may be used for any other type of signaling and/or indications, for example, that are received at a WTRU from a network entity.

Hereafter, for the brevity of discussion, the indications described may comprise a WUS. However, these examples and other examples described herein may be equally (or equivalently or extendedly, etc.) employed (e.g., applicable) for cases with other indication types and/or signaling types (e.g., paging, DCI, LP-WUS, etc.).

Hereinafter, ‘a,’ ‘an’ and/or similar phrases may be to be interpreted as ‘one or more’ and/or ‘at least one.’ Similarly, any term which ends with the suffix ‘(s)’ may be to be interpreted as ‘one or more’ and/or ‘at least one.’ The term ‘may’ may be interpreted as ‘may, for example.’

A symbol ‘/’ (e.g., forward slash) may be used herein to represent ‘and/or,’ where for example, ‘A/B’may imply ‘A and/or B.’

A WTRU may transmit or receive a physical channel and/or reference signal according to at least one spatial domain filter. The term “beam” may be used to refer to a spatial domain filter.

A WTRU may transmit a physical channel and/or signal using the same spatial domain filter as the spatial domain filter used for receiving a reference signal (RS) (such as a channel state information reference signal (CSI-RS)) or a synchronization signal (SS) block. The WTRU transmission may be referred to as “target,” and the received RS or SS block may be referred to as “reference” or “source.” In such a case, the WTRU may be said to transmit the target physical channel and/or signal according to a spatial relation with a reference to such an RS block and/or SS block.

A WTRU may transmit a first physical channel and/or signal according to the same spatial domain filter as the spatial domain filter used for transmitting a second physical channel and/or signal. The first and second transmissions may be referred to as “target” and “reference” (or “source”), respectively. In such case, the WTRU may be said to transmit the first (target) physical channel or signal according to a spatial relation with a reference to the second (reference) physical channel or signal.

A spatial relation may be implicit, configured by RRC or signaled by MAC CE or DCI. For example, a WTRU may implicitly transmit PUSCH and/or DM-RS of PUSCH according to the same spatial domain filter as an SRS indicated by an SRI indicated in DCI or configured by RRC. In another example, a spatial relation may be configured by RRC for an SRS resource indicator (SRI) or signaled by a medium access control element (MAC CE) for a physical uplink control channel (PUCCH). Such spatial relation may also be referred to as a “beam indication.”

A WTRU may receive a first (target) downlink channel and/or signal according to the same spatial domain filter and/or spatial reception parameter as a second (reference) downlink channel and/or signal. For example, such association may exist between a physical channel such as physical downlink control channel (PDCCH) or physical downlink shared channel (PDSCH) and its respective demodulation reference signal (DM-RS). At least when the first and second signals are reference signals, such an association may exist when the WTRU is configured with a quasi-colocation (QCL) assumption type D between corresponding antenna ports. Such an association may be configured as a transmission configuration indicator (TCI) state. A WTRU may receive an indication of an association between a CSI-RS (or SS block) and a DM-RS by an index to a set of TCI states configured by RRC and/or signaled by MAC CE. Such an indication may also be referred to as a “beam indication.”

Herein, a beam resource may comprise a TCI state, CSI-RS, a downlink reference signal (DL RS), or an SSB for downlink, a sounding reference signal (SRS) resource, an uplink reference signal (UL RS), or a TCI state for uplink. A beam resource may be identified by a beam indication.

Hereafter, a transmission and/or reception point (TRP) may be interchangeably used with one or more of transmission point (TP), reception point (RP), remote radio head (RRH), a distributed antenna (DA), a base station (BS), a sector (of a BS), and/or a cell (e.g., a geographical cell area served by a BS) without departing from the spirit and scope of this disclosure. Hereafter, multi-TRP may be interchangeably used with one or more of MTRP, M-TRP, and/or multiple TRPs without departing from the spirit and scope of this disclosure.

In the following, a property of a grant (e/g/, resource grant) and/or assignment may comprise at least one of the following: a frequency allocation; an aspect of time allocation, such as a duration; a priority; a modulation and coding scheme; a transport block size; a number of spatial layers; a number of transport blocks; a TCI state, a CSI resource indicator (CRI), or a sounding reference signal resource indicator (SRI); a number of repetitions; an indication of whether a repetition scheme is Type A or Type B; an indication of whether the grant is a configured grant type 1, type 2 or a dynamic grant; an indication of whether the assignment is a dynamic assignment or a semi-persistent scheduling (configured) assignment; a configured grant index or a semi-persistent assignment index; a periodicity of a configured grant or assignment; a channel access priority class (CAPC); and/or any parameter provided in a DCI, by MAC, or by RRC for scheduling the grant or assignment.

In examples described herein, an indication by DCI may comprise an explicit indication by a DCI field or by radio network temporary identifier (RNTI) used to mask or scramble a cyclic redundancy check (CRC) of the DCI.

Furthermore, in examples described herein, an indication by DCI may comprise an implicit indication by a property such as DCI format, DCI size, Coreset or search space, aggregation Level, first resource element of a received DCI (e.g., index of first control channel element), wherein a mapping between a property and a value may be signaled by RRC or MAC.

Receiving or monitoring for a DCI with and/or using an RNTI may indicate that the CRC of the DCI is masked and/or scrambled with the RNTI.

Hereafter, a signal may be interchangeably used with one or more of following: sounding reference signal (SRS), channel state information-reference signal (CSI-RS), demodulation reference signal (DM-RS), phase tracking reference signal (PT-RS), and/or synchronization signal block (SSB) without departing from the spirit and scope of this disclosure.

Hereafter, a channel may be interchangeably used with one or more of following: physical downlink control channel (PDCCH), physical downlink shared channel (PDSCH); physical uplink control channel (PUCCH), physical uplink shared channel (PUSCH), and/or physical random access channel (PRACH) without departing from the spirit and scope of this disclosure.

A WTRU may operate during (e.g., in) at least one of the one or more RRC states and/or RRC modes, for example including RRC-Connected state, RRC-Inactive state, and/or RRC-Idle state.

A WTRU may operate in an RRC-Connected state, during which the WTRU may have connected, established RRC context, and/or have at least one RRC connection, for example, to one or more cells, base stations, gNBs, TRPs, etc. In RRC-Connected state, the WTRU may receive RRC context and/or configuration information indicating at least including one or more radio bearers, logical channels, protocol data unit (PDU) sessions, security information, etc. During RRC-Connected state, a connected WTRU may measure one or more of reference signal received power (RSRP), reference signal received quality (RSRQ), received signal strength indicator (RSSI), etc. based on one or more received, detected, configured, and/or indicated reference signals (RSs) received from a serving cell and/or one or more neighboring cells. The connected WTRU may report the measured parameters, for example, to the serving cell.

A WTRU may operate in an RRC-Idle state, which may be the initial mode in which the WTRU operates when the WTRU is powered up. A WTRU in RRC-Idle state may be in a dormant state wherein the WTRU is not actively engaged in communication. The WTRU in RRC-Idle state may perform cell selection and/or cell reselection, wherein the WTRU may receive, detect, measure, and/or select an SSB. Based on the SSB, the WTRU may use a physical broadcast channel (PBCH), master information block (MIB), system information block (SIB), etc. The WTRU in RRC-Idle state may monitor a PDCCH (e.g., DCI, Format 1 0 using a paging RNTI (P-RNTI)) defined by a Discontinuous Reception (DRX) pattern. The WTRU may use respective 5G-S-TMSI to receive paging messages while the WTRI is in RRC-Idle state.

A WTRU may operate in an RRC-Inactive state, wherein the WTRU may keep RRC context and a CORE network connection and may not release the RRC when switching from RRC-Connected state to RRC-Inactive state. The WTRU in RRC-Inactive state may be in a sleep mode, similar to RRC-Idle state, wherein mobility may be handled through cell reselection without involvement of the network.

Hereafter, the terms ‘signal,’ ‘channel,’ and/or ‘message’ (e.g., as in downlink (DL) or uplink (UL) signal, channel, and/or message) may be used interchangeably without departing from the spirit and scope of this disclosure.

Hereafter, RS may be interchangeably used with one or more of RS resource, RS resource set, RS port, and/or RS port group without departing from the spirit and scope of this disclosure.

Hereafter, RS may be interchangeably used with one or more of SSB, low-power SS (LP-SS), CSI-RS, SRS, DM-RS, tracking reference signal (TRS), position reference signal (PRS), and/or phase tracking reference signal (PTRS) without departing from the spirit and scope of this disclosure.

Herein, time instance, slot, symbol, and/or subframe may be used interchangeably without departing from the spirit and scope of this disclosure.

Herein, the terms SSB, SS/PBCH block, PSS, SSS, PBCH, and/or MIB may be used interchangeably without departing from the spirit and scope of this disclosure.

Herein, SSB, SSB beam, and/or SSB index may be used interchangeably without departing from the spirit and scope of this disclosure.

Examples described hereafter may be used for transmissions and/or receptions occurring in a single or multiple cells, inter-cell, intra-cell, as well as single or multiple TRPs without departing from the spirit and scope of this disclosure.

Hereafter, CSI reporting may be interchangeably used with CSI measurement, beam reporting, and/or beam measurement without departing from the spirit and scope of this disclosure.

Hereafter, an RS resource set may be interchangeably used with a beam group without departing from the spirit and scope of this disclosure.

Herein, RSRP may be used interchangeably with RSSI, RSRQ, SNR, SS-RSRP, CSI-RSRP, SRS-RSRP, RSRP measured based on DMRS in PBCH, RSRP measured based on DMRS in PDCCH, RSRP measured based on DMRS in PDSCH, RSRP measured based on DMRS in PUCCH, RSRP measured based on DMRS in PUSCH, Low-Power RSRP (LP-RSRP), low power RSRQ (LP-RSRQ), and so forth without departing from the spirit and scope of this disclosure.

Herein, the terms “subgroup” and/or “subgroup ID” may be used interchangeably without departing from the spirit and scope of this disclosure.

Herein, the terms WUS MO and/or MO may be used interchangeably without departing from the spirit and scope of this disclosure.

A WTRU may receive, be configured with, and/or receive an indication of one or more WUS transmission occasions (WO). The WTRU may receive, be configured with, and/or receive an indication of time and/or frequency resources, periodicity, etc. for the configured WOs. The WOs may be configured with one or more parameters including at least one of WO periodicity, cell-ID, numerology (e.g., subcarrier spacing), WO length (e.g., number of symbols, slots, etc.), and/or frequency resources (e.g., number of resource elements (REs), resource blocks (RBs), bandwidth parts (BWPs), component carriers (CCs), etc.).

A WTRU may receive indications of the time and/or frequency resources for one or more WOs, based explicit indications and/or implicit indications.

In an example, a WTRU may receive an explicit indication in the form of one or more separate indications. For example, the WTRU may receive, be configured with, and/or receive indication(s) of one or more WO time resources, WO periodicity, etc.

In an example, a WTRU may receive an explicit indication in the form of a time offset with respect to a configured DRX cycle. In this example, WOs may be configured based on DRX configurations. That is, the WTRU may be configured with and/or receive indication(s) of with one or more WOs in DRX inactive time. For example, the WTRU may receive, be configured with, and/or receive an indication of a time offset with regards to the configured DRX active time as the time resources for one or more configured WOs. For example, the time offset may be before or after a configured DRX active time. In another example, the time offset may be in the middle of a configured DRX inactive time.

In an example, a WTRU may receive an explicit indication in the form of a time offset with regards to the paging frame. In this example, the WTRU may receive a frame offset for WUS. For example, the WTRU may receive offset from the start of a reference frame for WUS (e.g., the start of a frame) to the start of a first paging frame of paging frames associated with WUS monitoring for the WTRU. Based on the first paging frame, the WTRU may receive a symbol offset to a WO. For example, the WTRU may receive a symbol offset for WUS. For example, the WTRU may receive an offset (e.g., in number of symbols) from the start of the frame to the start of the first WUS occasion.

In an example, a WTRU may receive an implicit indication. For instance, if there is an absence of configured time and/or frequency resources for configured WOs, the WTRU (e.g., implicitly) may determine to use one or more default and/or configured configurations and/or indications for the configured WOs. In an example, the default and/or configured time resources may be determined with regards to a reference time instance (e.g., symbol, slot, frame, etc.). For example, the reference time may be determined with regards to Frame 0, a corresponding SSB, an associated DRX active or inactive time, etc. In another example, the default and/or configured frequency resources may be determined with regards to a reference frequency. For example, the reference point may be with regards to lowest PRB and/or center PRB within the configured CC (Component Carrier) and/or BWP (e.g., initial BWP, active BWP, etc.).

In an example of an implicit indication, if there is an absence of configured time and/or frequency resources for configured WOs, a WTRU (e.g., implicitly) may determine to use one or more configurations and/or indications for one or more paging slots. A paging slot may be configured with one or more parameters including at least one of paging cycle, cell-ID, numerology (e.g., subcarrier spacing), slot length (e.g., regular slot or mini-slot), and/or frequency resources. The paging slot may be interchangeably used with paging frame, cell-specific paging slot, and/or paging resources. The paging slot may include a PDCCH for paging monitoring and an associated PDSCH and/or the paging slot may include the PDCCH for paging monitoring alone. The WO associated with a paging slot may be indicated based on a time, a frequency, and/or an offset from the configured paging frame, etc.

In an example, WOs may receive an indication based on the configured WUS monitoring occasions. In an example, WOs may be a group of configured MOs.

Hereafter, the terms WO and/or MO may be used interchangeably without departing from the spirit and scope of this disclosure.

A WTRU may be configured with and/or receive an indication of one or more WUS MOs and/or sets of WUS MOs, for example, within each configured WO. For example, a set of MOs may include a determined, configured, and/or indicated number of MOs. In an example, the WTRU may be configured with and/or receive an indication of time and/or frequency resources, periodicity, number of MOs, number of sets of MOs etc. for one or more MOs and/or sets of MOs within each configured WO. The WTRU may receive the indications of the time and/or frequency resources for one or more MOs or sets of MOs, based on an explicit indication and/or an implicit indication.

As an example of an explicit indication of the time and/or frequency resources for one or more MOs or sets of MOs, the WTRU may be configured with and/or receive an indication of one or more MO time and/or frequency resources, MO periodicity, etc.

In an example, the WTRU may receive an implicit indication of the time and/or frequency resources for one or more MOs or sets of MOs. For example, if there is an absence of configured time and/or frequency resources for the configured MOs, the WTRU may (e.g., implicitly) determine MOs by using one or more default and/or configured configurations and/or indications. In an example, the default and/or configured time resources may be defined with regards to a reference time instance (e.g., symbol, slot, frame, etc.). For example, the reference time may be defined with regards to Frame 0, a corresponding SSB, an associated WO, etc. In another example, the default and/or configured frequency resources may be defined with regards to a reference frequency. For example, the reference point may be defined with regards to a lowest PRB and/or a center PRB within the associated WO, a configured CC, and/or a BWP (e.g., initial BWP, active BWP, etc.). For example, a time offset with regards to paging frame may be used. In an example, the WTRU may receive a frame offset for monitoring WUS. For example, the WTRU may receive an offset from the start of a reference frame for monitoring WUS (e.g., the start of a frame) to the start of a first paging frame of the paging frames associated with WUS monitoring for the WTRU. Based on the first paging frame, the WTRU may receive a symbol offset to a WUS monitoring occasion. For example, the WTRU may receive a symbol offset for monitoring WUS. For example, the WTRU may receive an offset (e.g., in number of symbols) from the start of the frame to the start of the first WUS monitoring occasion.

MOs may comprise beam-based MOs. In multi-beam WUS operation, a WTRU may be configured with one or more WUS MOs to monitor WUS, where the configured MOs may be associated with one or more beam resources. Herein, the beam resources may comprise SSB, CSI-RS, TCI-state, LP-SS, LP-WUS, WUS, SRS, DL/UL channels, and so forth. At a time, one of multiple candidate WUS indications (e.g., codepoint values, sequences, bitmap indications, etc.) may be transmitted in a set of WUS MOs (e.g., which may be associated with each beam and/or beam group). Different WUS MOs may be associated with one or more WTRU subgroups (SGs). In an example, the number of MOs within a WO and/or set of MOs may be associated with a configured number of beam resources (e.g., associated with and/or included in a configured cell, zone, etc.). For example, the number of MOs within a WO and/or set of MOs may be associated with a configured and/or indicated number of transmitted and/or configured LP-SSs, SSBs, RSs, etc.

For example, a first WO and/or set of MOs may constitute at least m MOs (e.g., where m may be a non-negative integer) to include the configured and/or transmitted m beam resources (e.g., LP-SSs, SSBs, etc.). At a time, a WTRU may receive at least one WUS indication in each first MO, wherein receiving the at least on WUS indication may trigger one or more SGs. For example, the WTRU may receive a first WUS triggering subgroup (SG 1) that may be associated with a WTRU subgroup 1 in a first MO associated with a first beam, the WTRU may receive a second WUS triggering subgroup (SG 2) that may be associated with a WTRU subgroup 2 in a second MO associated with a second beam, and so forth. In an example, a triggered SG (e.g., in a WUS MO) may indicate one or more WTRU subgroups. In another example, a triggered SG (e.g., in a WUS MO) may indicate multiple (e.g., all) WTRU subgroups (e.g., as in a common SG).

MOs may comprise zone-based MOs. A WTRU may be configured to monitor zone-based MOs. In zone-based WUS operation, the WTRU may be configured with one or more WUS MOs to monitor WUS, wherein the configured MOs may be associated with one or more configured zones.

In an example, the zones may be based on geographical zones. In an example, the WTRU may receive the configurations based on the WTRU's latest position and/or location (e.g., before WTRU falls to an RRC-Idle or RRC-Inactive mode). The WTRU may receive configuration information indicating one or more reference (e.g., geographical) points, threshold values, reference signals (RS), geographical coordinates (e.g., latitude, longitude, etc.), etc.

In another example, the zones may be based on spatial zones. In an example, the WTRU may receive the configurations based on the WTRU's latest beam direction and/or TCI-state that was used by the WTRU (e.g., for example before WTRU falls to an RRC-Idle and/or RRC-Inactive mode). For example, the WTRU may be configured with one or more spatial zones, wherein each zone may be associated with one or more beam resources, beam subsets, beam groups, etc. Configured beam resources, beam subset, and/or beam groups may include and/or be associated with beam resources, where the beam resources may be non-overlapped or partially overlapped. A spatial zone may be interchangeably used with a beam subset, a beam tracking area, a beam group, etc. In an example, the spatial zones may include a set of beam resources (e.g., DL/UL beam resources, SL beam resources, etc.). The WTRU may receive configuration information indicating the beam resources, beam sets, and/or beam groups associated with each spatial zone. For example, the configuration information may indicate one or more RS indexes (e.g., LP-SS, SSB, CSI-RS, etc.), QCL types, TCI states, etc. One or more spatial zones may be (pre)determined or (pre)defined and one of the spatial zones may be determined and/or selected. For example, a spatial zone may be selected and/or determined based on a radio quality measurement (e.g., of one or more beam resources (e.g., LP-SS, SSB, RSs, etc.)). For example, a WTRU may measure radio quality (e.g., RSRP, RSRQ, RSSI, etc.) of one or more beam resources (e.g., LP-SS, SSB, RS, etc.) and the WTRU may determine a beam which may provide a highest radio and/or beam quality. The WTRU may select a spatial zone which may include the corresponding determined beam (e.g., LP-SS, SSB, etc.).

At a time, one of multiple candidate codepoint values, sequences, bitmap indications, etc. may be transmitted in a set of WUS MOs (e.g., associated with each configured zones). Different WUS MOs may be associated with one or more WTRU subgroups (SG). In an example, the number of MOs within a WO or set of MOs may be associated with a configured number of zones.

A WTRU may be configured with and/or receive an indication of one or more subgroups. In an example, a WTRU may be configured with one or more WUS subgroups. The WTRU may monitor the WUS (e.g., monitor for a WUS) and may wake up if a received WUS includes (e.g., indicates) at least one of the WTRU's configured and/or indicated subgroups. In an example, the WUS may include one or more indications of the triggered subgroups based on a bitmap indication associated with a bitmap. Each bit in the bitmap may be associated with a respective WUS subgroup ID. In another example, the triggered WUS subgroups may be indicated based on a codepoint indication, where each codepoint may be associated with a respective one of the WUS subgroups. In another example, the triggered WUS subgroups may be indicated based on (e.g., overlaid) a sequence indication, wherein each (e.g., overlaid) sequence may be associated with a respective one of the WUS subgroups, and so forth. With a WUS that indicates the triggered subgroups, the WTRU may wake up if a received and/or detected WUS includes an indication of a subgroup to which the WTRU belongs to or which the ETRU monitors.

A WTRU may receive configuration information that indicates subgroups to which the WTRU belongs and/or subgroups the WTRU monitors. For example, a WTRU may be configured with and/or receive an indication of one or more subgroup IDs. In an example, the WTRU may be configured to and/or receive an indication to use one or more subgroup IDs based on a WTRU-ID-based subgrouping. In another example, a WTRU may be configured and/or receive an indication to use one or more subgroup IDs based on CN (Core Network)-assigned subgrouping.

For example, the WTRU may receive WUS-subgroup-related configuration information. The WUS-subgrouping-related information may indicate one or more of a number of subgroups for WUS, a WUS subgrouping ID, etc. In an example, the WTRU may receive an indication with a number of subgroups for WUS. In an example, the WTRU may receive an indication that a WUS subgrouping ID is the same as a paging subgrouping ID. In another example, the WTRU may receive an indication that the WUS subgrouping ID is different from the configured paging subgrouping ID. For example, the WTRU may be configured to and/or receive an indication to determine, select, and/or calculate the WUS subgrouping ID based on one or more configured paging subgrouping IDs. In another example, the WTRU may determine a subgroup ID based on the configuration of WUS including one or more of number of subgroups and/or the configured WTRU ID.

In an example, after a WTRU may detect and/or receive a WUS, the WTRU may determine if the WTRU's subgroup ID is indicated via the received and/or detected WUS. If the WTRU's subgroup ID is associated with at least one of the indicated subgroup IDs (e.g., received via WUS) the WTRU may wake up. In another example, the WTRU may be configured with and/or receive an indication of one or more “common” WUS subgrouping IDs, where the common subgrouping ID may be used to wake up all the WTRUs, regardless of their subgroup IDs. As such, if at least one of the common subgroup IDs is indicated and/or received via WUS, the WTRU may wake up.

In an example, a WTRU may be configured with one or more different subgroup IDs. For example, the configured subgroup IDs may be associated (e.g., with each other). In an example, the WTRU may determine, be configured to, and/or receive an indication to use at least one of the configured subgroup IDs for monitoring WUS based on one or more conditions. For example, the WTRU may be configured with a first subgroup ID, a second subgroup ID, and so forth. In an example, the WTRU may receive (e.g., explicitly) an indication of the different subgroup IDs. In another example, the WTRU may determine (e.g., implicitly) the subgroup IDs based on one or more configurations. For example, the WTRU may determine second, third, etc. subgroup IDs based on the first configured subgroup ID and/or one or more configured values, offset values, etc. In an example, the WTRU may add the first subgroup ID with a configured (e.g., offset) value to determine the second subgroup ID. In an example, the first subgroup ID may be based on a WTRU-ID.

In an example, a WTRU may be configured to use the first subgroup ID or second subgroup ID for monitoring WUS if the WTRU is operating based on a first mode of operation or a second mode of operation, respectively. In an example, the first mode of operation may comprise operating in RRC-Connected mode and the second mode of operation may comprise operating in RRC-Idle or RRC-Inactive mode. For example, the WTRU may receive the second subgroup ID via RRC, MAC-CE, DCI, SIB, etc. In an example, a WTRU may receive the second subgroup ID before the WTRU falls to an RRC-Idle and/or RRC-Inactive mode. In another example, the first mode of operation may operate based on a first service type (e.g., low latency), the second mode of operation may operate based on a second service type (e.g., low power), and other modes of operation may operate based on other respective service types.

In an example, a WTRU may be configured to use a first, second, or third subgroup ID for monitoring WUS if the WTRU is configured with a first type MO, a second type MO, or a third type MO (e.g., respectively). In an example, first type MOs may be based on MOs multiplexed in time, second type MOs may be beam-based MOs, third type MOs may be zone-based MOs, and so forth.

A WTRU may monitor and/or receive a wake-up signal (WUS) via a first radio (e.g., a low-power radio or ultra-low power radio). Receiving a WUS (e.g., an LP-WUS via the LR) may trigger wake up or usage of a second radio of the WTRU (e.g., the WTRU's main radio) for data and/or control signal transmission and/or reception. This has the potential to reduce the power consumption of wireless devices.

WUS for NR may be focused on supporting a deep sleep state for a MR while a WTRU is in RRC IDLE state or RRC INACTIVE state (referred to as IDLE/INACTIVE mode WUS monitoring) and on supporting the WTRU to skip monitoring a PDCCH while the WTRU is in RRC CONNECTED state (referred to as CONNECTED mode WUS monitoring).

DRX may be used to reduce WTRU power consumption by allowing the WTRU to periodically enter into a ‘power saving state’ (e.g., DRX inactive) during which WTRU suspends at least PDCCH monitoring. Further, the WTRU may be configured to suspend one or more additional operations (e.g., transmitting (e.g., periodic) CSI reports, L1-RSRP reports etc.) during DRX inactive time. To monitor and/or receive PDCCHs which may schedule possible DL and/or UL data and/or control transmissions, the WTRU may switch to an ‘active state’ for a limited time (e.g., DRX active time). During the ‘active state,’ the WTRU may also be configured to perform one or more dynamic and/or configured UL and/or DL transmissions and/or receptions (e.g., SRS transmission, CSI reporting, etc.). Once determined, scheduled, and/or configured UL/DL data and/or control transmissions and/or receptions are complete, the WTRU may return to the ‘power saving state.’

A WTRU may, for example, periodically monitor a PDCCH for a DL control information (DCI) and/or a DL assignment on a PDCCH masked with a P-RNTI (Paging RNTI) (e.g., when the WTRU is in RRC-Idle, RRC-Inactive, and/or RRC-Connected state). When a WTRU detects and/or receives a DCI and/or DL assignment using a P-RNTI, the WTRU may demodulate the associated or indicated PDSCH RBs and/or may decode a Paging Channel (PCH) that may be carried on an associated and/or indicated PDSCH. A PDSCH which may carry a PCH may be referred to as a PCH PDSCH. Paging, paging message, and/or PCH may be used interchangeably.

The Paging Frame (PF) and subframe within that PF, for example, the Paging Occasion (PO) that a WTRU may monitor for the Paging Channel (e.g., in RRC-Idle and/or RRC-Inactive State) may be determined (e.g., by the WTRU) based on the WTRU ID (e.g., WTRU-ID) and/or parameters which may be specified by the network. The parameters may comprise the Paging Cycle (PC) length (e.g., in frames) which may be the same as a DRX cycle and another parameter (e.g., base station) which, together with the PC length, may enable the WTRU to determine the number of PF per PC and the number of PO per PF which may be in the cell. For example, the WTRU ID may be the WTRU international mobile subscriber identity (IMSI) mod (e.g., modulus) 1024.

From the network perspective, there may be multiple PFs per paging cycle and/or multiple POs within a PF. For example, more than one subframe per paging cycle may carry PDCCH masked with a P-RNTI. Additionally, from the WTRU perspective, a WTRU may monitor a PO per paging cycle, and such a PO may be determined based on the parameters specified herein (which may be provided to the WTRU via system information, dedicated signaling information, and/or through other types of information). POs may include pages for one or more specific WTRUs and/or system information change pages which may be directed to each of the WTRUs. In RRC-Idle and/or RRC-Inactive State, a WTRU may receive pages for reasons such as an incoming call and/or system information update changes. In RRC-Connected State, a WTRU may receive pages related to system information change, for example, and the WTRU may not receive WTRU-specific pages such as those that may be used for an incoming call.

In RRC-Idle and/or RRC-Inactive States, a WTRU may monitor for or listen to a paging message to know about one or more of incoming calls, system information change, ETWS (Earthquake and Tsunami Warning Service) notification for ETWS capable WTRUs, CMAS (Commercial Mobile Alert System) notification, Extended Access Barring parameters modification, and so forth. A WTRU may monitor a PDCCH for P-RNTI discontinuously (e.g., to reduce battery consumption when there may be no pages for the WTRU). In an example, the WTRU may be configured with DRX for monitoring PDCCH discontinuously—for example, to monitor or listen for a to paging message during RRC-Idle and/or RRC-Inactive States (e.g., for receiving P-RNTI). In another example, a WTRU may be configured and/or enabled to use DRX in RRC-Connected State, wherein the WTRU may monitor the PDCCH discontinuously (e.g., using DRX operation).

If a WTRU does not monitor according to a configured PF, PO, DRX cycle, etc. the WTRU may not receive the transmitted PDCCH and may not perform the granted UL and/or DL transmission and/or reception. Such cases may happen if the WTRU is outside of a last served cell and cannot receive paging indications based on the configured PF, PO, etc. In this scenario, a NW may initiate paging escalation and/or paging missed procedures. The NW may initiate paging escalation if the WTRU misses a first paging (e.g., if the first paging attempt is not in the cell where the WTRU is camping). In paging escalation, the NW may retransmit a paging message in one or more other cells.

A similar procedure may be considered for WUS messages. For instance, a WTRU may miss a first WUS due to a first WUS transmission attempt not being transmitted in a cell where the WTRU is camping. As such, the NW may initiate WUS escalation (e.g., WUS re-transmission in one or more second cells).

A WTRU may use one or more DRX parameters that may be broadcasted (for example, in a system information block (SIB)) to determine a PF and/or PO to monitor for paging. The WTRU may (e.g., alternatively) use one or more WTRU-specific DRX cycle parameters that may be signaled to the WTRU (e.g., via RRC, MAC-CE, DCI, etc.), for example, as part of RRC release signaling.

In an example, a WTRU may determine a number of radio frames in the paging cycle based on the configured and/or indicated DRX cycle duration. A larger value of a DRX cycle duration may result in less WTRU battery power consumption. A smaller value of the DRX cycle duration may increase WTRU battery-power consumption. A DRX cycle may be cell specific or WTRU specific.

A DRX cycle may be cell specific and may be provided to at least some (e.g., all) WTRUs in a cell. The DRX cycle may be a default paging cycle. A DRX cycle may be WTRU specific. A WTRU may use the smaller of the default paging cycle and the WTRU-specific DRX cycle as the WTRU's DRX or paging cycle.

The WTRU may be configured with and/or receive an indication of a number of POs in a cell specific DRX cycle. The number of POs may be cell specific. The configured and/or indicated number of POs may depend on a paging capacity that may be desired and/or used in a cell. A larger number of POs may be used, for example, to increase paging capacity. A smaller number of POs may be used, for example, for a smaller paging capacity.

In an example, a WTRU-specific PO within a PF may be determined from (e.g., based on) a set of paging subframes. The set of paging subframes may be a function of predefined allowed subframes for paging and/or a number of POs per PF (which may be a function of at least the number of POs), a DRX cycle duration, and/or an SFN (System Frame Number). An SFN may have a range of values (e.g., from 0 through 1023).

In RRC-Connected State, a WTRU may determine PF and/or PO in a similar manner as in RRC-Idle state and/or RRC-Inactive state. DRX cycle parameters may be different for RRC-Idle, RRC-Inactive, and/or RRC-Connected states. A WTRU may monitor a (e.g., any) PO in a PC in RRC-Connected State, for example, to obtain system information change information.

A WTRU may use a (e.g., separate) low power-wake up receiver (LP-WUR) which may monitor low-power wake-up signals (LP-WUS) and trigger and/or wake-up a main radio receiver (MR) dedicated for data and/or control signal transmission and/or reception. The WTRU may be configured with one or more modes of operation, for example, in systems based on LP-WUS. In an example, a WTRU may be configured with an MR-ON mode and an MR-OFF mode. The WTRU may alternate and/or switch between operating in MR-ON mode and MR-OFF mode. In an example, the WTRU may save power by being in the MR-OFF mode. In another example, the WTRU may enter the MR-ON mode upon (e.g., in response to) receiving an LP-WUS.

A WTRU in MR-ON mode may turn on an MR and use the MR to send and/or receive channels, signals, etc. (e.g., to and/or from a base station). The WTRU in MR-ON mode may monitor, detect, receive, and/or measure one or more reference signals (e.g., SSB, CSI-RS, PT-RS, DR-RS, etc.).

A WTRU in MR-OFF mode may turn off an MR and may use an LP-WUR to receive one or more low-power signals, channels, etc. For example, the WTRU in MR-OFF mode may monitor, detect, receive, and/or measure one or more Low-Power Synchronization Signals (LP-SSs) and/or LP-WUS. During MR-OFF mode (e.g., while in MR-OFF mode), the WTRU may monitor to receive and/or detect one or more configured LP-WUS and may wake up the MR and/or switch to MR-ON mode upon reception of at least one LP-WUS.

The WTRU in MR-OFF mode may use LP-WUR to monitor an LP-SS signal to obtain (e.g., achieve) synchronization. In an example, a WTRU in RRC-Idle and/or RRC-Inactive states and in MR-OFF mode may have to switch to MR-ON mode and wake up the MR after receiving and/or detecting an LP-WUS. After waking up the MR and switching to MR-ON mode, the WTRU may monitor one or more paging occasions (POs), for example, to receive paging messages. After receiving a paging message and/or based on the received paging message, the WTRU may switch to RRC-Connected state and transmit and/or receive one or more indicated signals and/or channels, and so forth. After transmitting and/or receiving the indicated signals and/or channels, the WTRU may turn off the MR and switch back to MR-OFF mode. In another example, a WTRU in RRC-Connected state in MR-OFF mode may have to switch to MR-ON mode and wake up the MR after receiving and/or detecting an LP-WUS. After waking up the MR and switching to MR-ON mode, the WTRU may monitor to receive a PDCCH in one or more configured CORESETs (control channel resource sets) and/or CSS (common search space). The received PDCCH may include grant indications for one or more UL and/or DL transmissions and/or receptions. After transmitting and/or receiving based on the grant indications, the WTRU may turn off the MR and switch back to MR-OFF mode.

In this disclosure, procedures, configurations, and methods for selective paging for WUS based on subgroups (SG) are provided.

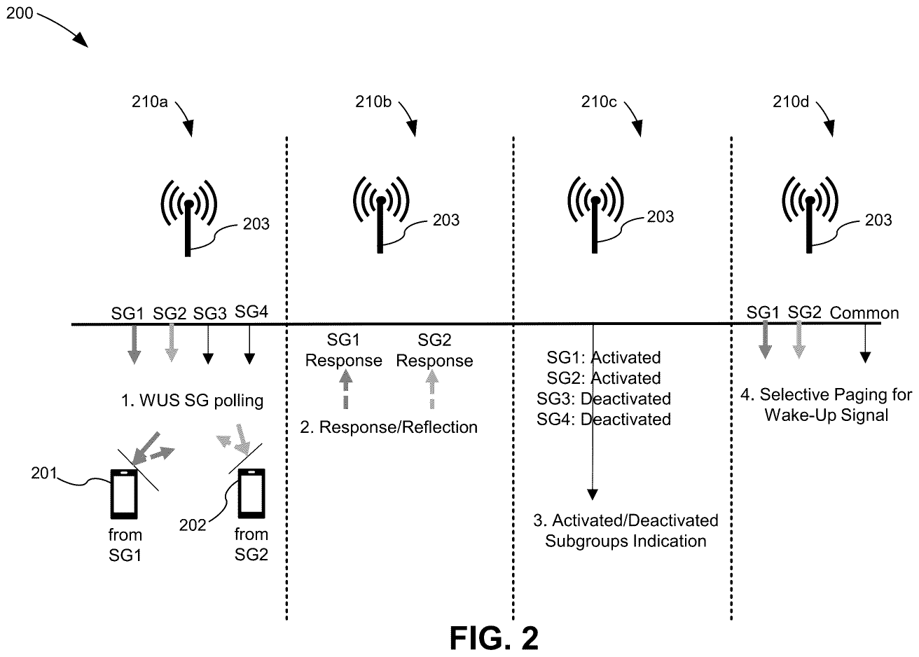

FIG. 2 shows a diagram 200 of a procedure for selective paging for WUS based on subgroups. A WTRU may be configured with different WUS subgrouping types (e.g., beam-based, zone-based, service-based, etc.). A WTRU may monitor at least a WUS subgroup indication based on the configured WUS subgrouping types. As shown in the diagram 200 in the first time window 210a, a WTRU 201 may be monitoring a subgroup SG1 and a WTRU 202 may be monitoring a subgroup SG2, wherein the WTRU 201 and the WTRU 202 may be in a same zone or may be served with a same beam and/or beam-group. As part of WUS polling systems, a WTRU may receive one or more WUS subgroup polling indications in different WUS polling occasions (e.g., SG1, SG2, SG3, SG4, etc.). Each WTRU may send a configured response or reflect the received signaling if the received WUS polling indication corresponds to WTRU's WUS subgroup. For example, the WTRU 201 may reflect the received SG1 signal toward the base station 203.

As shown in the time window 210b, as the base station 203 receives the responses from WTRUs, the base station may identify the WUS subgroups that are being monitored by at least a WTRU in the corresponding zone, beam, etc. The base station 203 may also identify the subgroups that no WTRU may be monitoring in the corresponding zone, beam, etc.

As shown in the time window 210c, the base station 203 may send an indication of the activated (e.g., SG1 and SG2) or deactivated (e.g., SG3 and SG4) WUS subgroups as part of a WUS polling procedure. From that point on, until the next WUS polling procedure, the base station 203 may perform selective WUS indication.

For instance, as shown in the time window 210d, the base station 203 may send WUS indications for the activated subgroups (e.g., SG1 and SG2) alone without sending WUS indications to the other subgroups (e.g., SG3 and SG4). The base station may also send a deactivated-group-common indication for the deactivated WUS subgroups (e.g., if required to do so).

In this section and following sections, different aspects and examples of this disclosure are provided.

A WTRU may determine, identify, and/or be configured with an ID. In an example, the ID may be based on a WTRU-ID, a beam ID, a cell ID, a zone ID, and so forth. In another example, a WTRU may receive configuration information indicating the WTRU's ID (e.g., via one or more of core network, RRC configuration, system information, MAC CE, DCI, etc.). Based on a type of the ID, different indication methods may be used. For example, for a first ID type (e.g., beam ID), a first indication method (e.g., one or more of system information, MAC CE and/or DCI) may be used. For a second ID type (e.g., zone ID), a second indication method (e.g., system information) may be used. For a third indication type (e.g., WTRU ID), a third indication method (e.g., RRC and/or core network) may be used.

A WTRU may determine, be configured with, and/or receive an indication of one or more wake-up signal (WUS) subgroups. The WTRU may determine the WUS subgroups and/or subgroup IDs based on the WTRU's configured ID. For example, the WTRU may determine and/or be configured with WUS related configuration including one or more of the following: a number of subgroups per one or more of MO, WO and/or PO; a number of subgroups for WTRU ID based subgrouping (e.g., per one or more of MO, WO and/or PO); and/or one or more configurations related to MOs and/or Wos. In an example, the WTRU may receive a configuration for identifying/determining time and/or frequency related configurations for MOs and/or WOs. For example, the WTRU may receive a periodicity and/or an offset (e.g., from a frame, a sub-frame, a slot, a paging frame, a paging occasion, etc.). For example, the WTRU may receive a frequency-related configuration including one or more of RBs, subbands, and/or bandwidth parts for MOs and/or WOs.

Based on the WUS related configuration and/or the ID, the WTRU may identify/monitor MOs and/or WOs for monitoring the WUS. For example, the WTRU may identify/monitor a MO according to a number of MOs divided by the ID (with potential ceiling/floor operations). In another example, the WTRU may monitor one or more MOs associated with a PO which is associated with the ID. In another example, the WTRU may receive an indication that indicates MOs/WOs to be monitored by the WTRU.

Based on the WUS related configuration and/or the ID, the WTRU may identify/monitor a subgroup associated with the WTRU. For example, the WTRU may divide the number of subgroups into the ID (with potential floor/ceiling operations) to identify the subgroup associated with the WTRU. Based on the identified subgroup, the WTRU may monitor a bit and/or a codepoint that is associated with the subgroup in the WUS.

A WTRU may determine and/or receive configuration information indicating the WUS subgroup ID that the WTRU is to monitor, for example, during WUS and/or paging occasions. For example, the WTRU may determine a paging occasion associated with the WTRU based on the equation i_s=floor (ID/N) mod Ns, wherein i_s may be a paging occasion index, N may be a number of total paging frames in a certain period, and Ns may be a number of paging occasions for a paging frame. In an example, a WTRU that is monitoring the WUS MOs may wake up if the WTRU receives a WUS including an indication to trigger at least one of the WUS subgroups that the WTRU is monitoring. In another example, a WTRU may monitor to receive one or more indications of the WTRU's subgroups within WUS MOs. The WTRU may determine and/or be configured to wake up if at least one of the received and/or indicated WUS subgroups in a WUS MO is associated with at least one of the WTRU's determined and/or configured subgroups. In an example, the received WUS may comprise an indication based on a codepoint, a sequence, a bitmap, and so forth.

Hereafter, for the brevity of discussion, the WUS indications may comprise the codepoints. However, examples in the disclosure may equally (or equivalently or extendedly, etc.) be employed (e.g., applicable) for cases with other indication types and/or signaling types (e.g., bitmap, sequence, etc.).

Herein, the terms subgroup, subgroup ID, paging subgroup, WUS subgroup, and/or LP-WUS subgroup may be used interchangeably without departing from the spirit and scope of this disclosure.

A WTRU may be configured with one or more WUS subgroups, wherein the WUS subgroups may be associated with and/or based on one or more WUS subgroup types. The WTRU may determine to wake up or not to wake up based on the received WUS subgroup and/or the associated WUS subgroup type. The WTRU may be configured with a first subgroup type, a second subgroup type, a third subgroup type, and so forth.

In an example, the first subgroup type may be based on WTRU-specific and/or group-specific first WUS subgroups. a WTRU may be configured with one or more WTRU-specific and/or group-specific first subgroups associated with first subgroup types. The WTRU may be configured with one or more first WUS associated with first subgroups. The WTRU may wake up after receiving a first type WUS and/or a first WUS.

In an example, the second subgroup type may be based on common second WUS subgroups, for example, including all WTRUs. The common second WUS subgroups may be based on cell-common, beam-common, zone-common, and/or service-common WUS subgroups. The WTRU may be configured with one or more common or all-WTRUs second subgroups associated with the second subgroup types. In an example, all WTRUs (e.g., within a cell, beam, zone, service, etc.) may wake up after receiving a WUS indicating and/or triggering the second subgroup.

In an example, the third subgroup type may be based on group-common third WUS subgroups. In an example, the group-common WUS subgroups may be based on deactivated-common subgroups. For example, if one or more of the WTRU's configured first subgroups and/or first subgroup types are deactivated, the WTRU may wake up after receiving a WUS indicating and/or triggering the third subgroup.

Other subgroup types are also possible.

In an example, a WTRU may receive configuration information indicating one or more WUS and/or paging polling procedures. The WTRU may receive configuration information on one or more polling occasions (e.g., one or more MOs and/or WOs for polling operation). In an example, the WTRU may receive indications of first type polling occasions, second type polling occasions, third type polling occasions, and so forth. The WTRU may receive a first, second, and/or third set of configuration information and/or indications for the first type, second type, and/or third type polling occasions, respectively (e.g., in a WUS-related configuration). The first, second, and/or third sets of configurations may be the same or different, wherein the WTRU may use the sets jointly or separately for determining the configured first, second, and/or third polling occasions and/or corresponding configurations, respectively. In an example, the different polling occasions (e.g., one or more MOs and/or WOs for polling operation) may be associated with one or more parameters, conditions, and so forth. For example, a type of polling occasion may be associated with one or more types of subgroups (e.g., beam ID based, zone ID based, WTRU ID based, etc.), beam resources, zones, services, and so forth.

In an example, the first type polling occasions may be based on beam-based polling occasions. In this example, in multi-beam WUS operation, the WTRU may be configured with one or more WUS polling occasions, wherein the configured polling occasions may be associated with one or more beam resources and/or beam IDs. At a time, one of the multiple WUS polling indications may be transmitted in one or more WUS polling occasions associated with one or more beams and/or beam groups. The WTRU may determine the one or more beam resources/IDs based on one or more measurements and/or indications.

In an example, a WTRU may determine the one or more beam resources (e.g., SSB and/or CSI-RS resources) and/or beam IDs (e.g., SSB IDs and/or CSI-RS resource IDs) based on measurements. For example, the WTRU may identify multiple beam resources (e.g., by receiving a configuration and/or blindly detecting the resources). The WTRU may measure multiple beam resources. Among the multiple beam resources, the WTRU may determine one or more beam resources with highest qualities (e.g., RSRP, RSRQ, SINR, RSSI, etc.) based on the measurements.

In an example, the WTRU may receive an indication of the one or more beam resources (e.g., via one or more of RRC, MAC CE, DCI, system information, etc.).

In an example, the second type polling occasions may be based on zone-based polling occasions. In this example, in zone-based WUS operation, a WTRU may be configured with one or more WUS polling occasions, wherein the configured polling occasions may be associated with one or more configured zones. In an example, the configured zones may be based on spatial zones, geographical zones, and so forth. At a time, one of the multiple WUS polling indications may be transmitted in one or more WUS polling occasions associated with one or more zones. The WTRU may determine the one or more zones/zone IDs based on one or more measurements and/or indications.

In an example, the WTRU may determine the one or more zones (e.g., SSB and/or CSI-RS resources) and/or zone IDs (e.g., SSB IDs and/or CSI-RS resource IDs) based on the measurements. For example, the WTRU may identify multiple zones (e.g., by receiving system information and/or RRC/MAC CE signaling). The WTRU may measure RSs associated with the multiple zones. For example, one or more RS resources may be associated with each zone/zone ID (e.g., respectively). The WTRU may measure the one or more RS resources associated (e.g., respectively) with the multiple zones/zone IDs. The WTRU may determine a quality for each zone (e.g., based on the best quality, average quality, the worst quality, etc.). Among the multiple zones/zone IDs, the WTRU may determine one or more zones/zone IDs with highest qualities (e.g., RSRP, RSRQ, SINR, RSSI, etc.) based on the measurements.

In an example, the WTRU may receive an indication of the one or more zones/zone IDs (e.g., via one or more of RRC, MAC CE, DCI, system information, etc.).

In an example, the third type polling occasions may be based on service-based polling occasions. In an example, in service-based WUS operation, the configured polling occasions may be associated with one or more service types. In an example, the services may be based on low latency, low power, reduced capability, coverage enhancement, and so forth. At a time, one of the multiple WUS polling indications may be transmitted in one or more WUS polling occasions associated with one or more services.

In an example, fourth type polling occasions may be based on WTRU-ID-based polling occasions. In an example, in WTRU-ID-based WUS operation, the configured polling occasions may be associated with one or more WTRU IDs or corresponding subgroups determined based on WTRU IDs. In an example, the WTRU IDs may be configured/indicated via one or more of RRC, MAC CE, DCI, system information and/or core network. At a time, one of the multiple WUS polling indications may be transmitted in one or more WUS polling occasions associated with one or more WTRU IDs/subgroups determined by WTRU IDs.

Other types of polling occasions are also possible.

A WTRU may receive configuration information indicating WUS polling procedures (e.g., from a base station), for example, via SIB, RRC, MAC-CE, DCI, etc. The configuration information may include one or more parameters and/or configurations (e.g., as described in the examples below).

In an example, the WTRU may be configured with time and/or frequency resources for the polling occasions. In an example, the time and/or frequency mappings may be indicated explicitly to the WTRU. In another example, the time and/or frequency resources may be configured with regards to one or more WOs and/or MOs. In another example, the time and/or frequency resources may be indicated based on one or more time and/or frequency references and one or more configured delta and/or offset time and/or frequency values, respectively.

In an example, a starting time of the WUS polling occasions may be defined with regards to Frame 0, an associated SSB, a WUS MOs starting time, a WOs starting time, an associated DRX active or inactive time, etc. In another example, a frequency reference point may be defined with regards to a lowest PRB and/or a center PRB within the configured WO, MO, CC, BWP, etc.

In an example, the one or more WUS polling occasions may be configured in a successive pattern. In another example, the placement in time and/or frequency of the polling occasions may be determined by a configured pattern and/or scheme. The WTRU may determine the pattern and/or scheme based on one or more configured parameters (e.g., polling occasion type, frequency range, subcarrier spacing (SCS), etc.).

In an example, the WTRU may be configured with a transmission type and/or periodicity (e.g., periodic, semi-persistent, and/or aperiodic polling occasions). The WTRU may receive the configuration information based on the transmission type. For example, the WTRU may receive a configuration including one or more periodicity values, offset values, etc., accordingly.

In an example, the WTRU may be configured to monitor to receive one or more indications in one or more configured and/or indicated WUS polling occasions. The WUS polling indications may be associated with one or more WUS subgroups and/or groups of WUS subgroups. The WUS polling subgroup indications may be similar to or different from WUS subgroup triggering indications. The WUS polling subgroup indications may be, for example, based on one or more codepoint values, sequences, bitmap indications, etc.

Herein, the terms WUS polling subgroups, WUS polling subgroup IDs, WUS polling subgroup indications, WUS polling indication, and/or WUS polling may be used interchangeably without departing from the spirit and scope of this disclosure.

The configured WUS polling subgroup indications may be based on the WUS polling occasions. In an example, a WTRU may be configured with one or more first WUS polling subgroups, one or more first WUS polling subgroup indications, etc. in the first type polling occasions. For example, the WTRU may monitor at least one of the configured first WUS polling subgroups in the beam-based polling occasions. The WTRU may be configured with one or more second WUS polling subgroups, one or more second WUS polling subgroup indications, etc. in the second type polling occasions. For example, the WTRU may monitor at least one of the configured second WUS polling subgroups in the zone-based polling occasions. The WTRU may be configured with one or more third WUS polling subgroups, one or more third WUS polling subgroup indications, etc. in the third type polling occasions. For example, the WTRU may monitor at least one of the configured third WUS polling subgroups in the service-based polling occasions, and so forth.

In an example, the WTRU may be configured with the time and/or frequency resources for determining a response occasion for sending one or more responses as part of the polling procedure. In an example, time and/or frequency mappings may be indicated explicitly to the WTRU. For example, the WTRU may be configured with one or more report configurations for reporting one or more parameters, measurements, and/or reports (e.g., with regards to polling). In another example, the time and/or frequency resources may be configured with regards to one or more WOs, MOs, and/or polling occasions. In another example, the time and/or frequency resources may be indicated based on one or more time and/or frequency references and one or more configured delta and/or offset time and/or frequency values, respectively.

In an example, a starting time of the response occasions may be defined with regards to Frame 0, an associated SSB, a WUS MOs starting time, a WOs starting time, a corresponding polling occasion, an associated DRX active or inactive time, etc. In another example, a frequency reference point may be defined with regards to a lowest PRB and/or a center PRB within the configured WO, MO, polling occasions, CC, BWP, etc.

In an example, the one or more response occasions may be configured and/or determined by a configured pattern and/or scheme. The WTRU may determine the pattern and/or scheme based on one or more configured parameters (e.g., polling occasion type, etc.).

In an example, the WTRU may be configured with the time and/or frequency resources for a second set of occasions, during which the WTRU may receive one or more indications of the activated and/or deactivated WUS subgroups. In an example, the time and/or frequency mappings may be indicated explicitly to the WTRU. In another example, the time and/or frequency resources may be configured with regards to one or more WOs, MOs, WUS polling occasions, etc. In another example, the time and/or frequency resources may be indicated based on one or more time and/or frequency references and one or more configured delta and/or offset time and/or frequency values, respectively.

In an example, the starting time of the second indication occasions may be defined with regards to Frame 0, an associated SSB, a WUS MOs starting time, a WOs starting time, associated WUS polling occasions, associated DRX active or inactive time, etc. In another example, a frequency reference point may be defined with regards to a lowest PRB and/or a center PRB within the configured WO, MO, CC, BWP, etc.

In an example, the one or more second indication occasions may be configured in a successive pattern. In another example, the placement in time and/or frequency of the second indication occasions may be determined by a configured pattern or scheme. The WTRU may determine the pattern based on one or more configured parameters (e.g., polling occasion type, frequency range, subcarrier spacing (SCS), etc. ).

Other types of parameters and/or configurations are also possible.

In an example, a WTRU may be configured with, receive an indication of, and/or determine a WUS polling subgroup and/or associated WUS polling subgroup indication from the configured one or more WUS polling subgroups. The WTRU may determine the WUS polling subgroup based WTRU-ID, a selected beam and/or beam ID, the WTRU's location and/or zone ID, and/or WTRU's service and/or service ID (e.g., as described in the following examples).

In an example, the WTRU may monitor the WUS polling subgroup indication associated with WTRU's WTRU-ID in one or more WUS polling occasions.

In an example, the WTRU may may receive an indication and/or select a beam (e.g., beam index) from a set of beam resources. The beam resources may comprise SSBs, CSI-RSs, TCI-states, UL or DL reference signals, etc. The WTRU may select a beam based on one or more measurements of one or more quality parameters. In an example, the WTRU may select a beam with a highest measured RSRP, etc. The WTRU may determine one or more WUS polling occasions associated with the selected beam and/or corresponding beam group (e.g., in beam-based WUS polling occasions). The WTRU may monitor the WUS polling subgroup indication associated with selected beam in one or more (e.g., determined) WUS polling occasions.

In an example, the WTRU may may receive an indication and/or determine a zone where the WTRU may be located, for example, based on WTRU's location. The zones may be based on geographical zones, spatial zones, etc. The WTRU may determine one or more WUS polling occasions associated with the indicated and/or determined zone (e.g., in zone-based WUS polling occasions). The WTRU may monitor the WUS polling subgroup indication associated with selected zone in one or more (e.g., determined) WUS polling occasions.

In an example, the WTRU may be operating based on one or more services. In this example, the services may be associated with one or more WTRU capabilities. The services may be based on low power, low latency, reduced capability, device type, etc. The WTRU may determine one or more WUS polling occasions associated with the indicated and/or determined service type (e.g., in service-based WUS polling occasions). The WTRU may monitor the WUS polling subgroup indication associated with WTRU's service in one or more (e.g., determined) WUS polling occasions.

The WTRU may also determine the WUS polling subgroup based on other factors.

Regarding first signaling, a WTRU may monitor to receive and/or detect one or more determined, configured, and/or indicated first WUS polling subgroup indications in one or more WUS polling occasions. The WTRU may receive one or more first WUS polling indications, messages, and/or signals in one or more WUS polling occasions. The WTRU may determine if the received first WUS polling indications are associated with at least one of WTRU's determined, selected, configured, and/or indicated WUS polling indications.

Herein, the terms WUS polling indication, message, and/or signal may be used interchangeably without departing from the spirit and scope of this disclosure.

In an example, a WTRU may send a determined, configured, and/or indicated response, message, signal, and/or report if the received WUS polling indication includes indications of at least one of WTRU's WUS subgroups. In an example, the WTRU may send the response (e.g., to a base station) to indicate that the corresponding WUS group should be active in the respective beam, zone, cell, service, etc. One benefit of the indication following WUS polling is that the base station may determine if there are WTRUs monitoring for the respective WUS subgroup or not in the corresponding beam, zone, cell, service, etc. In an example, the WTRU may determine that the WUS subgroups associated with the received WUS polling indications may are activated.

In an example, a WTRU may identify and/or be configured with one or more UL resources for sending a response. For example, one or more UL resources (e.g., for each type of subgroup) may be indicated via one or more of RRC, MAC CE and/or system information. The one or more UL resources may be one or more of on-off keying (OOK)-based resources, orthogonal frequency division multiplexing (OFDM)-based resources, PUCCH, PUSCH, PRACH, SRS, LP-UL RS, reflection-based resources, etc.

Regarding second signaling, in an example, a WTRU may receive one or more second indications indicating one or more activated and/or deactivated WUS subgroups (e.g., a type of subgroup to be activated/deactivated). The WTRU may receive the configuration information of the second set indication occasions as part of the polling occasion configurations. The WTRU may receive the indications on the activated WUS subgroups and the deactivated subgroups based on codepoints, bitmaps, sequences, etc. Based on the received second indications, the WTRU may determine if one or more of WTRU's WUS subgroups may be activated (e.g., in the corresponding beam, cell, zone, and/or service). In an example, the second signaling may be optional, where the WTRU may be configured with and/or receive an indication of whether the second signaling may be enabled or disabled (e.g., in the corresponding beam, cell, zone, service, etc.). In an example, the second set of indications may be re-transmitted in configured time and/or frequency resources. For example, the second set of indications may be transmitted periodically, semi-persistently, and/or aperiodically, in between polling occasions. In an example, a WTRU that has joined a beam, zone, service, etc. in between polling occasions may receive the indication and/or information of the activated or deactivated WUS subgroups based on received re-transmissions of the second set of indications.

If the WTRU receives an indication that and/or determines that one or more of WTRU's WUS subgroups are activated, the WTRU may monitor the corresponding WUS subgroup indications in one or more WUS MOs (e.g., based on corresponding beam, zone, service, etc.). If at least one of the WTRU's WUS subgroup indications is received and indicates the WTRU's wake-up subgroup, the WTRU may wake up (e.g., wake up the MR). The WTRU may monitor for one or more signals associated with paging in one or more paging occasions. If the WTRU receives a page, the WTRU may send a response to the page.

The WTRU may determine that one or more of WTRU's WUS subgroups may be deactivated (e.g., in the corresponding beam, cell, zone, and/or service). The WTRU may determine the deactivated WUS subgroups based on one or more WUS polling indications, polling indications that do not include indications of one or more of the WUS subgroups, and/or one or more second indications (e.g., as described in the examples below).

In an example, the WTRU may receive one or more WUS polling indications, wherein the received WUS polling indications may not indicate that one or more of the WUS subgroups are activated. In the absence of a WUS subgroup activation indication, the WTRU may determine that the corresponding WUS subgroup may be deactivated.

In an example, the WTRU may receive one or more WUS polling indications, wherein the received WUS polling indications may not include indications of one or more of the WUS subgroups. In the absence of the WUS subgroup activation or deactivation indication, the WTRU may determine that the corresponding WUS subgroup may be deactivated.

In an example, the WTRU may receive one or more second indications, where the received second indications may not indicate that one or more of the WUS subgroups are activated. In the absence of the WUS subgroup activation indication, the WTRU may determine that the corresponding WUS subgroup is deactivated. In another example, the received second indications may indicate that one or more of the WTRU's WUS subgroups are deactivated.

In an example, a WTRU may not receive an indication of the results of the polling. For instance, the WTRU may not receive indications of the activated or deactivated WUS subgroups. For example, a WTRU may join a beam, a zone, a service, etc. in between polling occasions. In another example, the WTRU may not receive a second indication (e.g., due to a higher priority UL or DL grant, measurements, beam failure, etc.). As such, the WTRU may determine the activated or deactivated WUS subgroups based on received configuration information. The WTRU may receive the configuration information that indicates the activated or deactivated WUS subgroups, for example, from a base station (e.g., via SIB, RRC configurations, periodic second indications, etc.).

In an example, a WTRU may be configured with, receive an indication of, and/or determine the mode of operation if the WTRU receives an indication that and/or determines that one or more WUS subgroups may be deactivated. In an example, the WTRU may receive configuration information of one or more modes of operation and one or more corresponding threshold values (e.g., from a base station via SIB, RRC, MAC-CE, DCI, etc.). The WTRU may be configured to operate based on a first mode of operation, a second mode of operation, and/or another mode of operation. In an example, one or more of the modes of operation described in the following examples may apply.

In an example, the WTRU may be configured to operate based on monitoring deactivated-group-common signaling. For example, the WTRU may determine, be configured to, and/or receive an indication to monitor the WUS MOs to receive one or more configured group-common WUSs. In an example, the group-common WUSs may be associated with deactivated WUS subgroups. The WTRU may monitor the group-common indication for deactivated subgroups. In another example, the WTRU may determine, be configured, and/or receive an indication to monitor for one or more (e.g., deactivated) subgroup WUS indications also.

In an example, the WTRU may be configured to operate based on ending an indication. For example, the WTRU may determine to, be configured to, and/or receive an indication to wake up (e.g., wake up the MR) and to send one or more indications. In an example, the WTRU may send the indications to a base station. For example, the WTRU may be configured with one or more time and/or frequency resources for sending the indications (e.g., as part of a configured HARQ-ACK transmission, special SR transmission, PRACH transmission, etc.). The WTRU may send the indication to indicate that the corresponding WUS subgroup may have to be activated. The indication may include one or more WUS subgroup indexes. Meanwhile, before receiving an indication and/or confirmation from the base station of whether to activate or deactivate the WUS subgroups, the WTRU may monitor the WUS MOs to receive one or more configured group-common WUS for deactivated WUS subgroups in addition to the WTRU's WUS subgroups (e.g., even if the WTRU's WUS subgroups are deactivated).

In an example, the WTRU may be configured to operate based on deactivating WUS monitoring. For example, the WTRU may determine to, be configured to, and/or receive an indication to deactivate WUS monitoring based on one or more conditions. The WTRU may wake up (e.g., wake up the MR) and monitor possible paging signaling reception (e.g., via the MR). In an example, the WTRU may be configured with one or more threshold values for one or more measured quality parameters. Based on the one or more threshold values for one or more measured quality parameters, the WTRU may determine to deactivate WUS monitoring. In an example, the WTRU may determine to continue monitoring WUS (e.g., based on WTRU's WUS subgroup indication, or group-common indication for deactivated subgroups) based on a measured RSRP. In an example, the WTRU may monitor WUS if the measured RSRP (e.g., based on the received WUS, associated RS, SSB, LP-SS, etc.) is higher than a configured threshold value. In another example, the WTRU may stop monitoring WUS and deactivate monitoring WUS if the measured RSRP is lower than the configured threshold value.

Other modes of operation may also apply.

In an example, a WTRU with one or more deactivated WUS subgroups may determine, be configured with, and/or receive an indication of the mode of operation if one or more WUS indications corresponding to all WTRUs and all subgroups are received in one or more MOs. In an example, the WTRU may receive one or more “common” WUS subgrouping IDs, wherein the one or more common subgrouping IDs may be used to wake up all the WTRUs (e.g., regardless of the WTRUs'subgroup IDs). In an example, the WTRU may be configured with a first mode of operation, wherein the first mode of operation may comprise waking up (e.g., waking up the MR). In another example, the WTRU may be configured with a second mode of operation, where the second mode of operation may comprise not waking up (e.g., not waking up the MR).

As part of WUS polling, a base station may identify WUS subgroups for which responses were received from the WTRUs. That is, the base station may identify the WUS subgroups that may be monitored by WTRUs (e.g., in the corresponding zone, area, cell, beam, etc.). As such, the base station may send a WUS subgroup indication to the activated WUS subgroups without sending the WUS subgroup indication to other subgroups. The base station may, for instance, not transmit the WUS subgroup indication for the deactivated WUS subgroups. The base station may send one or more group-common WUS indications for one or more of the deactivated WUS subgroups.

If at least one of the determined, configured, and/or indicated WUS subgroup indications is received, the WTRU may wake up (e.g., wake up the MR). The WTRU may monitor for one or more signals associated with paging in one or more paging occasions. If the WTRU receives a page, the WTRU may send a response to the page.

In one example, a WTRU may determine, or receive configuration information indicating, how the WTRU may send one or more indications to the network after the reception of a WUS polling indication. For instance, the configuration information may indicate time and/or frequency resources, formats, and/or conditions for the WTRU to perform the transmissions. In an example, the WTRU may send to the network the WTRU's configuration and/or radio capabilities (e.g., for MR and/or LR based transmissions). For instance, the WTRU may send a set of supported radios and/or radio configurations or a set of WTRU types and/or categories indicating which transmission and/or transmission configuration is supported by the WTRU. The WTRU may send an indication of this capability (e.g., via RRC configuration or using NAS configuration).

The WTRU may receive one or more configurations for responding to a received WUS polling subgroup indication (e.g., corresponding to one or more radio configurations or capabilities available at the WTRU). The WTRU may receive the one or more configurations (e.g., configuration information) from the network using one or more of: SIB indications (e.g., SIB1 or a SIB including low-power configuration), RRC signaling, and/or MAC or PHY layer indications.

For example, the WTRU may be configured to reflect and/or amplify-and-reflect one or more received WUS subgroup polling indications. For instance, the WTRU may be configured with reflection in radios capable of reflecting and/or forwarding a received signal, low-power radio transmitters, battery-less transmitters, and so forth. In some options, the WTRU may receive indications and/or configurations such as one or more of those described in the following examples.

In an example, the WTRU may reflect and/or forward only a configured set (e.g., subset) of received signals (e.g., the signals matching the monitored signaling associated with one or more WTRU's WUS subgroups—e.g., codepoints, bit indications, etc.).

In an example, the WTRU may be configured to detect the corresponding WUS subgroup polling indications and to enable the transmission if (e.g., only if) detected signal is valid.

In an example, the WTRU may be configured with (e.g., receive configuration information indicating) resources where to perform (e.g., which to use for performing) the reflected transmission.

In an example, the WTRU may be configured to reflect the transmission with a specific time offset and/or delay (e.g., by temporarily storing the received signal energy or using the WTRU's own energy source) and reflect the received signal at another time instance based on the received configured time indication (e.g., offset, delay, etc.).

In an example, the WTRU may be configured with a time window during which the WTRU may continue to reflect the received WUS subgroup polling indications. The WTRU may reflect the received WUS subgroup polling indications, for example, if (e.g., only if) the received indications correspond to at least one of WTRU's configured WUS subgroups. One benefit of such a time window may be that the WTRU may also reflect the reflections received from other WTRUs (e.g., monitoring for the same WUS subgroups). As such, the multiple reflections may help with coverage enhancement and increase the probability of the reception of the responses at the NW side.

In an example, the WTRU may be configured for response transmission using a separate signal generated in a different UL sub-band. The WTRU may be configured to reflect the transmission with a different frequency resource than the received signal (e.g., to mitigate interference with the original signal). For example, the WTRU may be configured with a first frequency resource (e.g., LP sub-band, DL sub-band, etc.) where (e.g., in which) to receive the WUS polling indication and a second frequency resource (e.g., LP sub-band, UL sub-band, etc.) where (e.g., in which) to transmit the response. The WTRU may use a (e.g., Low-Power) transmitter on the transmission sub-band based on the WTRU's capabilities. The WTRU may receive a configuration to link the reception and/or transmission resources to determine which transmission resource to use whenever a WUS polling indication is received.

In an example, the WTRU may be configured for response transmission using one or more configured and/or indicated shared resources and/or common signaling (e.g., wherein multiple WTRUs may be configured to transmit a response to the polling WUS indication). For example, configuration information for response transmission using one or more configured and/or indicated shared resources and/or common signaling indicate information described in one or more of the following examples.

In an example, the configuration information may indicate time and/or frequency resource(s) for the response transmission (e.g., as a preconfigured time and/or frequency position) (e.g., configured with absolute references and/or periodic indications). The WTRU may also be configured relative to the received polling indication (e.g., with time and/or frequency offset with reference to the MOs, WOs, polling occasions, etc.). The WTRU may determine the transmission resources based on the received polling indication and the configured time and/or frequency offsets and/or periodic resources configured for transmissions (e.g., the next occurrence following the reception).

In an example, the WTRU may be configured with resources for transmission radios (e.g., Low-Power transmission radios) (e.g., in band, sub-band, carrier, BWP, and/or resources configured for transmissions). In one example, the WTRU may transmit using the resources and LP radio and may avoid waking up the MR to perform the transmission (e.g., response transmission).

In another example, the WTRU may be configured with resources for transmission radios during wake-up mode (e.g., MR wake-up mode) (e.g., in band, sub-band, carrier, BWP, and/or resources configured for transmissions) (e.g., for WTRUs that either have to wake up their MRs for transmission or that have incoming configured and/or prepared wakeup times and/or time windows).

In an example, the WTRU may determine transmission parameters (e.g., within the configured resources) for how to transmit. This may enable multiple WTRUs to transmit and/or report in the same configured resources with reduced collisions and/or interference and may help the network to identify the WTRU that is transmitting.

For example, the WTRU may use a subset of the resources (e.g., a specific symbol time, a specific subset of frequencies, etc.) based on the WTRU ID or the WTRU's subgroup.

For example, the WTRU may determine a random (e.g., pseudorandom) subset of the resources on which to transmit.

For example, the WTRU may transmit a sequence or information bits including the WTRU's WTRU ID, subgroup ID, received codepoint, etc. In another example, the WTRU may be configured with a WTRU-specific sequence and/or codepoint.

For example, the WTRU may be configured to share a group-common or cell-common sequence or codepoint with other WTRUs and jointly transmit in the configured time and/or frequency resources. The sharing of resources may enhance coverage and increase the probability of reception and detection of the response at the NW (e.g., at the base station).

In one example, the resources may be configured to respond in a configured random access channel (RACH) resource, wherein these specific RACH resources (e.g., following a WUS polling occasion) may be configured for responding.

Regarding WTRU-specific signaling, a WTRU may receive configuration information indicating resources for configured (e.g., WTRU-specific) signaling (e.g., hybrid automatic repeat request acknowledgment (HARQ-ACK), special SR, etc.) after waking up. In one example, the WTRU may be configured to wake up (e.g., wake up the MR) to transmit the polling indication responses.

In one example, the WTRU may be configured to wake up following WUS polling signaling reception to perform the transmission in the configured resources.

In another example, the WTRU may be configured to wait for a next wake-up time (e.g., wake up for another configured occasion (e.g., mobility indication, CSI reporting, HARQ reporting etc.)) to perform the transmission in the configured resources.

The WTRU may be configured to perform the transmission using dedicated resources (e.g., using PUCCH resources or uplink control information (UCI) on PUSCH resources). For instance, the WTRU may be configured to perform the transmission reusing configured HARQ feedback resources (e.g., transmitting an ACK or NACK to indicate the response to the WUS polling). In another example, the WTRU may be configured to perform the transmission reusing an SR format or an indication, wherein the WTRU may use a configured bit or bit sequence indication to indicate that the transmission corresponds to the WUS polling response. In another example, WTRU may be configured to perform the transmission using a new dedicated response format (e.g., on a PUCCH or a PUSCH) corresponding to the WUS polling response (e.g., using one or more bits for transmitting the response).

The WTRU may transmit the response jointly with another transmission (e.g., HARQ feedback, SR, CSI report, etc.). For example, the WTRU may transmit the response within the same PUCCH, PUSCH or UCI resources.

Regarding special resources, a WTRU may be configured with (e.g., receive one or more indications of) resources using single-tone and/or multi-tone transmission with very narrow bandwidth and/or large repetitions (e.g., for LP transmitters). The WTRU may receive the configuration for the corresponding resources where to transmit based on the single or multi-tone transmission radio capabilities. The configuration may indicate time (e.g., as a delay and/or offset from the WUS polling indication and/or monitoring occasion) and/or frequency (tone) resources to use for transmission.

A WTRU may be configured with one or more radios to be used for transmission of one or more responses, reports, etc. The WTRU may receive configuration information indicating different configurations that may be associated with different configured radios. In an example, the WTRU may be configured with a first set of configuration information to be used to send the response based on a first radio. In addition, the WTRU may be configured with a second set of configuration information to be used to send the response based on the second radio. The WTRU may also be configured with other sets of configuration information to be used to send the response based on other radio types. The configuration information may indicate one or more threshold values.

In an example, a WTRU may determine a radio to be used for transmitting the response to the received WUS polling indication based on supported radios (e.g., supported by the WTRU), activated radios (e.g., activated at the WTRU), and/or other WTRU-related conditions. For example, the conditions may indicate battery and/or energy levels, WTRU type, WTRU category, measurements, etc. The WTRU may determine the resources to use to transmit the response based on a selected radio and a corresponding received resource configuration. In some examples, these may be combined (e.g., as described in the examples below).

In an example, the WTRU may select one of the radio(s) or configuration(s) corresponding to an activated radio(s) or radio configuration(s) when receiving the WUS polling indication.

For example, the WTRU may be configured with a radio with one or more configurations or with multiple active radios when the WUS polling indication is received. The WTRU may select one of these radios and/or configurations to respond to the network.

In an example, the WTRU may use and/or select one of the radio(s) or configuration(s) based on timing between the received WUS polling indication and a next expected wake-up time.

For example, the WTRU may be configured with a maximum delay (e.g., number of symbols, slots, milli-second, etc.) for responding to the WUS polling indication and may select a radio (e.g., configuration) that is expected to be active during that delay. For example, if the WTRU is expecting to wake up its MR within the configured delay, the WTRU may use the MR radio. In another example, if the next wakeup period is beyond the configured delay, the WTRU may use an active and/or LR-based radio.
In an example, the WTRU may select one of the radio(s) or configuration(s) based on measurements of one or more received signals (e.g., from the network). In an example, the WTRU may use the measurements to determine which radio (e.g., configuration) has sufficient coverage for sending the respond to the network. In an example, the WTRU may perform the measurements based on one or more reference signals, SSB, CSI-RS, LP-SS, etc. The WTRU may measure one or more quality parameters (e.g., RSRP, RSRQ, etc.). The WTRU my determine the radio and/or configuration to be used based on the measurements and/or one or more configured and/or indicated threshold values.

For example, each received radio and corresponding configuration to be used to respond to the WUS polling indication may be associated with a threshold (e.g., based on LP-SS or LP-WUS measurements). If the measured signal for a radio is higher than the threshold, the WTRU may use that radio and corresponding configuration to respond. Otherwise, the WTRU may not use that radio. By default, if no radio and/or corresponding configuration satisfies the criterion (e.g., is higher than a corresponding threshold), the WTRU may wake up (e.g., wake up the MR) to respond.
In an example, the WTRU may select one of the radio(s) or configuration(s) based on battery and/or energy levels (e.g., by selecting a radio or configuration with a lower power consumption if the battery and/or remaining energy is lower than a configured corresponding threshold; selecting a radio or configuration with a higher power consumption if the battery and/or remaining energy is higher than the configured corresponding threshold; etc.).

The WTRU may use the determined radio and/or corresponding configuration to transmit and/or reflect a signal in response to a received WUS polling indication. The WTRU may determine to transmit or not transmit based on the received WUS polling indication. For example, the WTRU may initiate the response (e.g., transmission and/or reflection) if the received WUS polling indication corresponds to a monitored WUS subgroup. In this scenario, the WTRU may prepare the determined and/or configured corresponding radio for the transmission and/or reflection in the determined resources. The WTRU may perform further actions, for example, such as waking up a corresponding radio (e.g., associated with the transmission) and/or establishing any synchronization, activation, measurement or calibration).

In the transmission (e.g., response transmission), the WTRU may include in the response information. The response information may comprise a binary indication to indicate to the network that the WTRU received the monitored WUS subgroup polling indication. The response information may comprise the corresponding received WUS polling indication to indicate to the network that the WTRU responding to the polling is in response to the received WUS polling indication (e.g., for shared resources). The indication may be explicit (e.g., in bits of data) or implicit (e.g., based on the used resources—e.g., a subset of resources used for different WUS responds).

In an example, a WTRU may receive an indication (e.g., for WUS polling) (e.g., based on WTRU responses). The indication may indicate activated and/or deactivated subgroups and/or one or more types of subgroups (e.g., to be activated), as described in the following examples.

In an example, the WTRU may receive an indication of activated/deactivated subgroups. For example, a base station may indicate a set of activated subgroups and/or a set of deactivated subgroups. The indication may be transmitted via one or more of WUS, RRC, MAC CE, DCI, and/or SI.

The indication may be based on one or more of codepoints. For example, each codepoint may be associated with one or more subgroups to be activated.

The indication may be based on a bitmap. For example, each bit in the bitmap may be associated with a respective subgroup to be activated. For example, if a bit associated with a subgroup indicates 0, then the respective subgroup may be deactivated. Otherwise (e.g., the bit value is 1), the respective subgroup may be activated.

The indication may be based on a hybrid indication. For example, the WTRU may receive an indication including one or more codepoint values followed by one or more bitmap indications. In this example, each codepoint may indicate a subgroup type (e.g., beam-based, zone-based, service-based, etc.) and may be followed by a bitmap indicating the activated and/or deactivated subgroups corresponding to the indicated subgroup type.

The WTRU may receive an indication of one or more types of subgroups. In an example, the WTRU may receive an indication of a type of subgroup (e.g., to be activated). For example, the WTRU may support one or more subgroup types, as indicated in the examples below.

In an example, the WTRU may support WTRU-ID-based subgroups. For example, subgroups associated with the WTRU may be identified based on a configured WTRU ID for the WTRU. The WTRU ID may be configured via one or more of core network, RRC, MAC CE, DCI and/or SI.

In an example, the WTRU may support zone-based subgroups. For example, subgroups may be associated with a zone ID that the WTRU determined (e.g., based on channel quality measurements (e.g., based on RSRP, RSRQ, RSSI, SINR, etc.)).

In an example, the WTRU may support beam-based subgroups. For example, subgroups may be associated with a beam (e.g., one or more of an SSB, a CSI-RS and/or a TCI state) that the WTRU determined (e.g., based on channel quality measurements (e.g., based on RSRP, RSRQ, RSSI, SINR, etc.)).

In an example, a WTRU may determine a payload size for activated/deactivated subgroups based on an indicated type of subgroups. For example, L1 bits (e.g., wherein L1 may be a non-negative integer) may be used for activation/deactivation of subgroups that are of a first type of subgroup (e.g., WTRU ID based). L2 bits (e.g., wherein L2 may be a non-negative integer) may be used for activation/deactivation of subgroups of a second type of subgroup (e.g., beam/zone based).

In another example, a payload size for activated/deactivated subgroups may be determined based on a maximum payload size for a plurality of candidate subgroups. For example, L1 bits may be a maximum payload size for activation/deactivation of subgroups based on a first type of subgroup (e.g., WTRU ID based). If L2 bits are required for the second type of subgroups, L1-L2 most-significant-bit/least-significant-bit (MSB/LSB) bits may be padded (e.g., with zeros, ones, predetermined sequences, etc.) for activation/deactivation of subgroups.

In an example, the WTRU may determine one or more configurations of active monitoring occasions (MOs) and wake-up signal occasions (WOs) (e.g., based on the indication of activated/deactivated subgroups). Based on the determined active MOs and WOs, the WTRU may determine MOs and WOs to be monitored by the WTRU. The WTRU may use methods to determine the MOs and WOs to be monitored, as described in the following examples.

In an example, the WTRU may determine the one or more configurations based on the activated type of subgroup. For example, the WTRU may identify a total number of subgroups based on the activated type of subgroup and identify a number of MOs and WOs based on the activated type of subgroup.

In an example, the WTRU may determine the one or more configurations based on a number of activated types of subgroups. For example, two or more types of subgroups may be activated. In this case, the total number of subgroups may be L1 (e.g., for a first activated type of subgroup)+L2 (e.g., for a second activated type of subgroup). Based on the total number of subgroups, the WTRU may identify a number of MOs and WOs.

In an example, the WTRU may determine the one or more configurations based on activated subgroups. For instance, the WTRU may determine the configuration of the activated MOs and WOs. The WTRU may determine one or more locations of MOs and WOs based on the total number of subgroups based on the activated type of subgroup. Among the MOs and WOs, MOs and WOs associated with the activated subgroups may be activated (MOs and WOs not associated with the activated subgroups may not be activated).

In another example, the WTRU may determine one or more locations of MOs and WOs based on the activated number of subgroups based on the activated type of subgroup. For example, MOs and WOs may be configured for the activated number of subgroups.

In an example, the WTRU may determine a mode of operation based on an activated type of subgroup. For example, the WTRU may use a set of measurement configurations (e.g., for entry/exit condition of WUS monitoring) associated with each set of activate type of subgroups.

The set of measurement configurations may indicate a type of measurement. For example, the WTRU may determine one or more of RSRP, RSRQ, RSSI, SINR, pathloss, estimated distance (e.g., from a zone center), etc.

The set of measurement configurations may indicate one or more thresholds. For example, the WTRU may be configured with a different set of entry/exit thresholds for WUS monitoring for each set of measurement configurations, respectively.

The set of measurement configurations may indicate a WTRU-indication-related configuration.

In an example, the WTRU may indicate that the WTRU has to fall back (e.g., when a measurement is lower than an exit threshold). The fallback indication may be different based on the activated type(s) of subgroup(s). For example, if a first type of subgroup (e.g., zone-based subgrouping) is activated, the WTRU may indicate a first indication (e.g., out of zone). If a second type of subgroup (e.g., beam based) is activated, the WTRU may indicate a second indication (e.g., out of beam coverage). The WTRU may use different WTRU-indication-related configurations for each set of measurement configurations (e.g., respectively).

In an example, the WTRU may use a UL indication method. For example, one or more of PUCCH, PUSCH, PRACH, sequence-based transmission, reflection-based transmission, etc. may be configured.

In an example, the WTRU may use a UL indication resource. For example, one or more UL resources for a WTRU indication may be configured.

In an example, a WTRU may receive configuration information associated with receiving enhanced WUS indications. In an example, a WTRU may be experiencing low coverage with respect to monitoring WUS subgroup indication, reception of WUS, reception of WUS polling indication, transmission of response to a WUS polling, and so forth. For example, the WTRU may receive configuration information and/or indications, from a base station (e.g., via SIB, RRC, MAC-CE, DCI, etc.).

In an example, a WTRU may be configured with a first set of configurations and a second set of configurations corresponding to first WUS indications and second WUS indications, respectively. In an example, the configured second WUS indications may be based on enhanced WUS indications. For example, the WUS configurations may indicate (e.g., comprise indications of) threshold values, a WUS transmission power, polling response target power, a number of WUS repetitions, a number of response transmission (Tx) repetitions, a sequence length, and/or a bandwidth, as described in the examples below.

In an example, the WTRU may be configured with one or more threshold values regarding the WUS procedure. In an example, the threshold values may be applicable to measured RSRP, RSSI, RSRQ, SINR, etc. For example, the WTRU may use the threshold values for determining exit conditions from WUS operation.

In an example, the WTRU may be configured with the WUS transmission power with respect to one or more reference signals. In an example, the WTRU may be configured with one or more power offset values with respect to the transmission power of one or more reference signals (e.g., SSB, LP-SS, etc.).

In an example, the WTRU may be configured with the UL target power regarding one or more response and/or report transmissions.

In an example, the WTRU may be configured with one or more repetition numbers for receiving WUS indications, WUS polling indications, etc.

In an example, the WTRU may be configured with one or more response transmission repetitions. The WTRU may select the number of response transmission repetitions from preconfigured repetition values. The WTRU may select the repetition value, for example, based on one or more measured quality parameters. The WTRU may select the number of repetitions, for example, based on measured RSRP, RSSI, RSRQ, SINR, etc. (e.g., measured based on one or more reference signals, SSB, CSI-RS, LP-SS, etc.). In an example, the WTRU may select a first repetition value if the measured RSRP is higher than a threshold value. The WTRU may select a second repetition value, wherein the second repetition value may be higher than the first repetition value, if the measured RSRP is lower than the threshold value, and so forth.

In an example, the WTRU may be configured with a length of WUS sequences. In an example, the WTRU may be configured with a length of overlaid OFDM WUS sequences. In another example, the WTRU may be configured with a length of binary WUS sequences.

In an example, the WTRU may be configured with the bandwidth used for the reception of WUS indications.

In an example, the second WUS indications and the corresponding second set of WUS configurations may be associated with enhanced WUS operation. In an example, the second WUS configurations may indicate a higher transmission power, a higher number of repetitions, a longer sequence length, and/or a higher bandwidth (e.g., compared to the first set of WUS configurations).

In an example, based on results from a WUS polling, a base station may determine and/or indicate WUS subgroups for which an enhanced WUS is to be transmitted. For example, the base station may determine the WUS subgroups to be indicted by an enhanced WUS indication based on the signal quality of responses received during WUS polling from WTRUs monitoring the WUS subgroup.

In an example, a WTRU that joins WUS monitoring in between WUS polling occasions may determine one or more WUS configurations based on one or more indications and/or configurations. The WUS configurations may indicate WO types, WUS subgroup types, activated and/or deactivated WUS subgroups, and so forth. The WTRU may receive the one or more indications from a base station (e.g., via SIB, RRC, MAC-CE, DCI, etc.)

In an example, a WTRU may switch to a new beam (e.g., a beam other than a beam the WTRU was previously using) in beam-based WUS MOs. The WTRU may receive WUS configurations with regards to the new beam. In another example, the WTRU may move to a new zone in zone-based WUS MOs and may receive WUS configurations with regards to the new zone. In another example, the WTRU may use or switch to a new service in service-based WUS MOs. The WTRU may receive WUS configurations with regards to the new service, and so forth.

In an example, the WTRU may receive configuration information indicating one or more substitute subgroups and/or substitute subgroup types to be used in WUS monitoring occasions. The WTRU may receive the configuration information from a base station (e.g., via SIB, RRC, MAC-CE, DCI, etc.). Based on a received indication (e.g., which the configuration information comprises), the WTRU may monitor a substitute WUS subgroup indication in WUS MOs for waking up. In an example, the WTRU may be configured to and/or receive an indication to use the substitute WUS subgroup indication if (e.g., only if) the WTRU's subgroup is deactivated. As such, if the WTRU's subgroup is activated, the WTRU may monitor to receive the activated subgroup ID. However, if WTRU's subgroup is deactivated, the WTRU may monitor the substitute subgroup instead.

In an example, the WTRU may be configured to and/or receive an indication to monitor both the WTRU's configured subgroup and one or more group-common WUS subgroups if the WTRU has joined WUS monitoring in between WUS polling occasions. For example, the WTRU may be configured to and/or receive an indication to monitor deactivated-group-common WUS indications after joining WUS monitoring (e.g., until a next WUS polling occasion). In an example, the WTRU may receive such indications indicating one or more substitute subgroups and/or substitute subgroup types to be used in WUS monitoring occasions explicitly or implicitly, as described in the examples below.

In an example, the WTRU may receive explicit indications to monitor one or more of the WTRU's subgroup WUS indications (e.g., WUS indications for subgroups that comprise the WTRU) in addition to one or more group-common WUS indications.

In an example, in the absence of indications on the activated or deactivated WUS subgroups, the WTRU may determine (e.g., implicitly) to monitor one or more of the WTRU's subgroup WUS indications (e.g., WUS indications for subgroups that comprise the WTRU) in addition to one or more group-common WUS indications. In another example, if the NW does not support indication (e.g., via a SIB) of activated and/or deactivated WUS subgroups, the WTRU may determine to monitor one or more of the WTRU's subgroup WUS indications in addition to one or more group-common WUS indications.

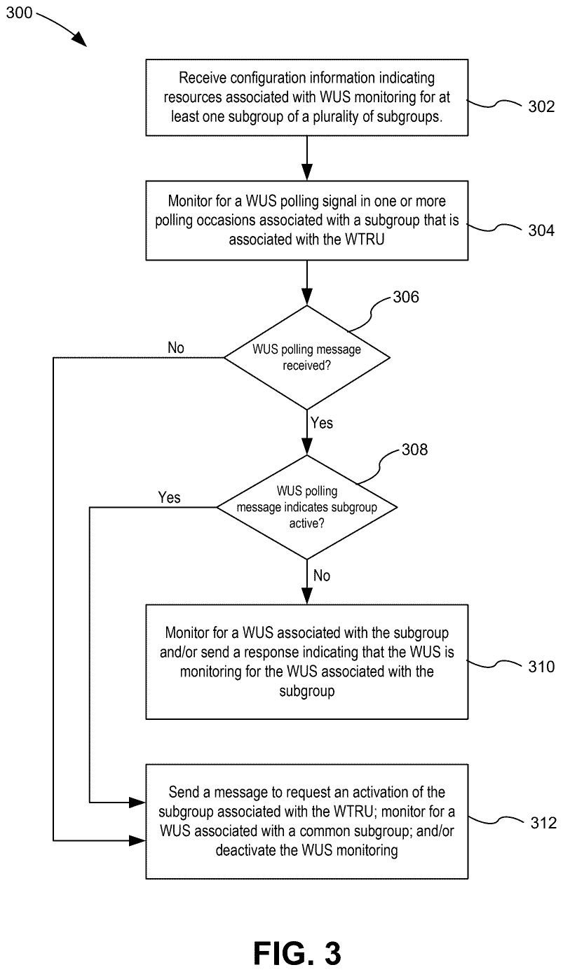

FIG. 3 illustrates an example flow diagram 300 of an example process (e.g., method) for selective paging for wake-up signals that a WTRU may perform in accordance with some examples found in the present disclosure. In some examples, some of the actions shown in the blocks 302-312 may be performed concurrently or in orders other than the order shown in the flow diagram 300. Furthermore, in some examples, some of the actions shown in the flow diagram 300 may be omitted or additional actions not shown in the flow diagram 300 may be performed without departing from the spirit and scope of this disclosure.

At block 302, the WTRU may receive configuration information, wherein the configuration information may indicate resources associated with wake-up signal (WUS) monitoring for at least one subgroup of a plurality of subgroups. The plurality of subgroups may comprise, for example, WUS subgroups and/or polling subgroups.

In some examples, the WTRU may receive (e.g., as part of the configuration information or in a separate communication) an indication of polling resources (e.g., POs) to monitor for each polling subgroup of a plurality of polling subgroups (e.g., wherein the plurality of polling subgroups may be plurality of subgroups and/or a subset thereof). In such examples, the WTRU may determine (e.g., identify) a polling subgroup for the WTRU (e.g., based on beam measurements, location of the WTRU, and/or services the WTRU supports).

At block 304, the WTRU may monitor for a WUS polling signal in one or more polling occasions associated with a subgroup that is associated with the WTRU. The subgroup that is associated with the WTRU may comprise, for example, a WUS subgroup and/or a polling subgroup.

At block 306, the WTRU may receive a WUS polling message (or may not receive a WUS polling message). If the WTRU does not receive the WUS polling message (e.g., within a configured amount of time), the flow of the flow diagram 300 may proceed to block 312. If the WTRU does receive the WUS polling message, the flow of the flow diagram 300 may proceed to block 308.

At block 308, the WTRU may determine whether the WUS polling message indicates that the subgroup associated with the WTRU is active. If the WUS polling message indicates that the subgroup associated with the WTRU is active, the flow of the flow diagram 300 may proceed to block 310. If the WUS polling message indicates that the subgroup associated with the WTRU is not active, the flow of the flow diagram 300 may proceed to block 312.

In some examples, if the subgroup associated with the WTRU comprises a WUS subgroup, determining whether the WUS polling message indicates that the subgroup associated with the WTRU is active may comprise determining whether the WUS subgroup is active for a determined polling subgroup for the WTRU.

At block 310, the WTRU may monitor for a WUS associated with the subgroup and/or send a response indicating that the WUS is monitoring for the WUS associated with the subgroup.

At block 312, after either (i) failing to receive the WUS polling message (e.g., within a configured amount of time) or (ii) determining that the WUS polling message indicates that the subgroup associated with the WTRU is not active, the WTRU may perform one or more actions. One possible action may be that the WTRU sends a message to request an activation of the subgroup associated with the WTRU. Another possible action may be that the WTRU monitors for a WUS associated with a common subgroup. Another possible action may be that the WTRU deactivates the WUS monitoring (e.g., for the WUS monitoring for the at least one subgroup of the plurality of subgroups, for the WUS associated with the subgroup associated with the WTRU, and/or for the WUS associated with the common subgroup).

In some examples, the common subgroup may be associated with each subgroup of the plurality of subgroups.

In some examples, the plurality of subgroups may comprise one or more activated subgroups and one or more deactivated subgroups, the common subgroup may be associated with the one or more deactivated subgroups (e.g., but not with the one or more activated subgroups), and the one or more deactivated subgroups may comprise the subgroup that is associated with the WTRU. In such examples, if the WTRU does not receive the WUS polling message or if the processor receives the WUS polling message and the WUS polling message indicates the subgroup associated with the WTRU is not active, the WTRU may monitor for the WUS associated with the common subgroup based on the association of the common subgroup with the one or more deactivated subgroups.

In some examples, if the WTRU receives the WUS associated with the common subgroup, the WTRU may wake up a main radio (MR) (e.g., a main radio of the WTRU) and monitor, via the MR, for one or more signals associated with paging. If the WTRU receives the one or more signals associated with paging, the WTRU may send a response to the one or more signals associated with paging.

In some examples, if the WTRU does not receive the WUS polling message or if the processor receives the WUS polling message and the WUS polling message indicates the subgroup associated with the WTRU is not active, the WTRU may determine whether to deactivate the WUS monitoring based on whether a condition is satisfied. The condition is based on a measured quality parameter. For instance, the condition may indicate a threshold value for the measured quality parameter. The WTRU may compare the measured quality parameter to the threshold value and determine whether to deactivate the WUS monitoring based on the comparison of the measured quality parameter to the threshold value.

In some examples, each subgroup of the plurality of subgroups may be respectively associated with one or more beams, zones, and/or services.

In some examples, the WTRU may determine the subgroup is associated with the WTRU based on an identifier (ID) associated with the WTRU.

In some examples, the subgroup may comprise a WUS polling subgroup. In such examples, the WUS polling message may indicate that a wake-up subgroup associated with the WTRU is active for the WUS polling subgroup.

In some examples, the WUS polling message may indicate that the subgroup associated with the WTRU is active via at least one of a bitmap indication, a codepoint indication, or a sequence indication.

In some examples, If the WTRU receives the WUS polling message and the WUS polling message indicates the subgroup associated with the WTRU is active, the WTRU may identify (i) a type of subgroup that is activated or (ii) a number of types of subgroups that are activated; and determine a number of monitoring occasions (MOs) to be monitored based on (i) the type of subgroup that is activated or (ii) the number of types of subgroups that are activated.

1. A wireless transmit/receive unit (WTRU) comprising:
a processor configured to:
receive configuration information, wherein the configuration information indicates resources associated with wake-up signal (WUS) monitoring for at least one subgroup of a plurality of subgroups;
monitor for a WUS polling message in one or more polling occasions associated with a subgroup that is associated with the WTRU;
wherein, if the processor receives the WUS polling message and the WUS polling message indicates the subgroup associated with the WTRU is active, the processor is configured to:
(i) send a response indicating that the WTRU is monitoring for a WUS associated with the subgroup; or
(ii) monitor for a WUS associated with the subgroup; and
wherein, if the processor does not receive the WUS polling message or if the processor receives the WUS polling message and the WUS polling message indicates the subgroup associated with the WTRU is not active, the processor is configured to:
(i) send a message to request an activation of the subgroup that is associated with the WTRU;
(ii) monitor for a WUS associated with a common subgroup; or
(iii) deactivate the WUS monitoring.

2. The WTRU of claim 1, wherein the common subgroup is associated with each subgroup of the plurality of subgroups.

3. The WTRU of claim 1, wherein:
the plurality of subgroups comprises one or more activated subgroups and one or more deactivated subgroups;
the common subgroup is associated with the one or more deactivated subgroups;
the one or more deactivated subgroups comprise the subgroup that is associated with the WTRU; and
wherein, if the processor does not receive the WUS polling message or if the processor receives the WUS polling message and the WUS polling message indicates the subgroup associated with the WTRU is not active, the processor is configured to:
monitor for the WUS associated with the common subgroup based on the association of the common subgroup with the one or more deactivated subgroups.

4. The WTRU of claim 3, wherein, if the processor receives the WUS associated with the common subgroup, the processor is configured to:
wake up a main radio (MR); and
monitor, via the MR, for one or more signals associated with paging.

5. The WTRU of claim 4, wherein, if the processor receives the one or more signals associated with paging, the processor is further configured to:
send a response to the one or more signals associated with paging.

6. The WTRU of claim 1, wherein, if the processor does not receive the WUS polling message or if the processor receives the WUS polling message and the WUS polling message indicates the subgroup associated with the WTRU is not active, the processor is configured to:
determine whether to deactivate the WUS monitoring based on whether a condition is satisfied, wherein the condition is based on a measured quality parameter.

7. The WTRU of claim 6, wherein the condition indicates a threshold value for the measured quality parameter, and wherein, if the processor does not receive the WUS polling message or if the processor receives the WUS polling message and the WUS polling message indicates the subgroup associated with the WTRU is not active, the processor is configured to:
compare the measured quality parameter to the threshold value; and
determine whether to deactivate the WUS monitoring based on the comparison of the measured quality parameter to the threshold value.

8. The WTRU of claim 1, wherein each subgroup of the plurality of subgroups is respectively associated with one or more beams, zones, or services.

9. The WTRU of claim 1, wherein the processor is configured to:
determine that the WTRU is associated with the subgroup of the plurality of subgroups based on one or more of (i) a synchronization signal block (SSB) measurement, (ii) beam measurements, (iii) a location of the WTRU, or (iv) a service supported by the WTRU.

10. The WTRU of claim 1, wherein the processor is further configured to:
determine the subgroup is associated with the WTRU based on an identifier (ID) associated with the WTRU.

11. The WTRU of claim 1, wherein the subgroup comprises a WUS polling subgroup, and wherein the WUS polling message indicates that a wake-up subgroup associated with the WTRU is active for the WUS polling subgroup.

12. The WTRU of claim 1, wherein the WUS polling message indicates that the subgroup associated with the WTRU is active via at least one of a bitmap indication, a codepoint indication, or a sequence indication.

13. The WTRU of claim 1, wherein, if the processor receives the WUS polling message and the WUS polling message indicates the subgroup associated with the WTRU is active, the processor is configured to:
identify (i) a type of subgroup that is activated or (ii) a number of types of subgroups that are activated; and
determine a number of monitoring occasions (MOs) to be monitored based on (i) the type of subgroup that is activated or (ii) the number of types of subgroups that are activated.

14. A method performed by a wireless transmit/receive unit (WTRU), the method comprising:
receiving configuration information, wherein the configuration information indicates resources associated with wake-up signal (WUS) monitoring for at least one subgroup of a plurality of subgroups;
monitoring for a WUS polling message in one or more polling occasions associated with a subgroup that is associated with the WTRU;
receiving the WUS polling message, wherein the WUS polling message indicates that the subgroup associated with the WTRU is not active;
based on the WUS polling message indicating that the subgroup associated with the WTRU is not active, monitoring for a WUS associated with a common subgroup.

15. The method of claim 14, further comprising:
after receiving the WUS polling message indicating that the subgroup associated with the WTRU is not active, sending a message to request an activation of the subgroup associated with the WTRU.

16. The method of claim 14, wherein:
the plurality of subgroups comprises one or more activated subgroups and one or more deactivated subgroups;
the common subgroup is associated with the one or more deactivated subgroups;
the one or more deactivated subgroups comprise the subgroup that is associated with the WTRU; and
wherein the method comprises:
monitoring for the WUS associated with the common subgroup based on the association of the common subgroup with the one or more deactivated subgroups.

17. The method of claim 16, further comprising:
receiving the WUS associated with the common subgroup;
based on the WUS associated with the common subgroup, waking up a main radio (MR); and
monitoring, via the MR, for one or more signals associated with paging.

18. The method of claim 17, further comprising:
receiving the one or more signals associated with paging; and
sending a response to the one or more signals associated with paging.

19. The method of claim 14, further comprising:
determining whether to deactivate the WUS monitoring based on whether a condition is satisfied, wherein the condition is based on a measured quality parameter.

20. The method of claim 19, wherein the condition indicates a threshold value for the measured quality parameter, and wherein the method further comprises:
comparing the measured quality parameter to the threshold value; and
determining whether to deactivate the WUS monitoring based on the comparison of the measured quality parameter to the threshold value.
